(19) United States
(12) Patent Application Publication
(10) Pub. No.: US 2012/0076204 A1
(43) Pub. Date: Mar. 29, 2012

(54) METHOD AND APPARATUS FOR SCALABLE MULTIMEDIA BROADCAST USING A MULTI-CARRIER COMMUNICATION SYSTEM

(75) Inventors: Vijayalakshmi Raveendran, San Diego, CA (US); Samir S. Solim, San Diego, CA (US)

(73) Assignee: QUALCOMM Incorporated, San Diego, CA (US)

(21) Appl. No.: 12/889,159

(22) Filed: Sep. 23, 2010

(51) Int. Cl. H04N 7/32; H04N 7/24

(52) U.S. Cl. 375/240.12; 375/240.01; 375/E07.021; 375/E07.243

(57) ABSTRACT

A wireless distribution system is provided where multiple carrier frequencies/channels are used to facilitate transmission of scalable multimedia content. Some carrier frequencies are assigned to carry base layer data for one or more program/content channels and some other carrier frequencies are assigned to carry data for one or more enhancement layers associated with the base layer data of one or more program/content channels. The enhancement layer carrier frequency may be shared among program/content channels transmitted over multiple different base layer carrier frequencies. Different numbers of enhancement layers and their bandwidth may correspond to different refinements of the multimedia content.

### BACKGROUND

1. Field

Various features pertain to wireless transmission of digital multimedia content. At least one feature pertains to devices and methods for scaling digital multimedia content transmissions over a multi-carrier communication system.

2. Background

As mobile communication devices evolve, they are capable of providing more services and/or content to mobile users. One type of multimedia content that such mobile communication devices may receive is video content. As digital video content can be received on mobile communication devices of different display resolutions and/or varying bandwidth reception capabilities (e.g., mobile wireless devices, fixed display devices over cable/fiber optics, etc.), audio and/or video content may be transmitted/broadcasted in various formats of varying quality and/or bandwidth requirements. In some content distribution systems, hierarchical modulation schemes may be implemented to deliver varying quality or resolution of video content. In some examples, such hierarchical modulation schemes (also referred to as layered modulation schemes) often multiplex and/or modulate multiple data streams/bitstreams into one single symbol stream or bitstream, comprising base layer bitstream/symbols and enhancement layer bitstream/symbols. The combined multiplexed base layer and enhancement layer bitstreams are then transmitted using a single carrier frequency. Use of the enhancement layer permits improving video content quality and/or resolution at the receiving device(s). However, current hierarchical modulation schemes are susceptible to degradation (e.g., due to interlayer interference, etc.) so that the quality and/or resolution of transmitted video content that can be displayed on a receiver device is adversely affected. Other types of layering and/or modulation schemes may also be susceptible to such degradation.

Therefore, a content broadcasting method and/or apparatus is needed that can provide improved content quality and/or resolution distribution to wireless receiver devices.

### SUMMARY

A first feature provides a method operational in a transmitter device. Content for one or more multimedia content channels is obtained (e.g., received from a content source). A content of a first multimedia content channel is then converted to a scalable format, where the first multimedia content may include a first base layer bitstream and a first enhancement layer bitstream. The first base layer bitstream is then transmitted over a first carrier frequency while the first enhancement layer bitstream is transmitted over a second carrier frequency. The first enhancement layer bitstream may include refinement content of the first base layer bitstream. In various examples, the first enhancement layer bitstream may be synchronously transmitted with the first base layer bitstream or the first enhancement layer bitstream may be orthogonally transmitted relative to the first base layer bitstream transmission.

The first base layer bitstream may include a plurality of intra-coded picture frames (I-frames) and predicted picture frames (P-frames). The first enhancement layer bitstream includes a plurality of bi-predictive picture frames (B-frames). The first base layer bitstream may provide the first multimedia content according to a first format, where a format refers to at least one of a quality, resolution, frame rate, bit depth, or multi-view characteristic. The first base layer bitstream in combination with the first enhancement layer bitstream may provide the first multimedia content according to a second format, where the second format improves at least one characteristic of the first format.

The first multimedia content may further include a second enhancement layer bitstream that enhances a display characteristic achievable by the first base layer bitstream in combination with the first enhancement layer bitstream where such display characteristic refers to at least one of a quality, resolution, frame rate, bit depth, or multi-view characteristic. The second enhancement layer bitstream may be transmitted over the second carrier frequency. The first base layer bitstream transmission and the first enhancement layer bitstream transmission may have co-extensive coverage regions. That is, the first base layer bitstream and first enhancement layer bitstream may be broadcasted with identical patterns. Alternatively, the transmissions of the first base layer bitstream and first enhancement layer bitstream are broadcasted with dissimilar patterns. For instance, the first enhancement layer bitstream transmission may be directionally beam-formed to target a sub-region within a coverage region of the first base layer bitstream. In one example, the first base layer bitstream transmission and the first enhancement layer bitstream transmission may occur within a forward link only distribution network.

According to one aspect, a content of a second multimedia content channel may be converted to the scalable format, wherein the second multimedia content includes a second base layer bitstream and a second enhancement layer bitstream. The first and second base layer bitstreams may be multiplexed prior to transmission. The second base layer bitstream is then transmitted over a first carrier frequency. Similarly, the first and second enhancement layer bitstreams may be multiplexed prior to transmission. The second enhancement layer bitstream may then be transmitted over the second carrier frequency.

According to another aspect, content of a second multimedia content channel is converted to the scalable format, wherein the second multimedia content includes a second base layer bitstream and a second enhancement layer bitstream. The second base layer bitstream may be transmitted over the third carrier frequency. The second enhancement layer bitstream may be transmitted over the second carrier frequency such that the second carrier frequency is shared by enhancement layer bitstreams of different multimedia content.

Similarly, a transmitter device may be provided comprising a processing circuit and a communication circuit. The processing circuit may be adapted to obtain content for one or more multimedia content channels. The processing circuit may then convert a content of a first multimedia content channel to a scalable format, wherein the first multimedia content includes a first base layer bitstream and a first enhancement layer bitstream. The communication circuit may be configured to transmit the first base layer bitstream over a first carrier frequency and transmit the first enhancement layer bitstream over a second carrier frequency. The first enhancement layer bitstream may include refinement content of the first base layer bitstream. For instance, the first base layer bitstream may provide the first multimedia content according to a first format, where a format refers to at least one of a quality, resolution, frame rate, bit depth, or multi-view characteristic. However, the first base layer bitstream in combination with the first enhancement layer bitstream provides the first multimedia content at a second format, where the second format improves at least one characteristic of the first format.

In one implementation, the first multimedia content may further include a second enhancement layer bitstream that enhances a display characteristic achievable by the combination of the first base layer bitstream in combination with the first enhancement layer bitstream, where such display characteristic refers to at least one of a quality, resolution, frame rate, bit depth, or multi-view characteristic.

In another implementation, the communication circuit may be further configured to convert a content of a second multimedia content channel to the scalable format, wherein the second multimedia content includes a second base layer bitstream and a second enhancement layer bitstream. The second base layer bitstream may then be transmitted over the third carrier frequency. The second enhancement layer bitstream is transmitted over the second carrier frequency such that the second carrier frequency is shared by enhancement layer bitstreams of different multimedia content (e.g., where the corresponding base layer bitstreams may be transmitted over the same or different carrier frequencies).

A second feature provides a method operational in a receiver device. A first base layer bitstream is received over a first carrier frequency and a first enhancement layer bitstream is received over a second carrier frequency. A first multimedia content is then reconstructed by combining the first base layer bitstream and the first enhancement layer bitstream. The reconstructed first multimedia content may then be provided to at least one of a display device, a storage device, or an external playback device. The first enhancement layer bitstream may include refinement content of the first base layer bitstream. In one implementation, the first enhancement layer bitstream is synchronously received with the first base layer bitstream. Additionally, the first enhancement layer bitstream may also be orthogonally received relative to the first base layer bitstream transmission. The first base layer bistream may include a plurality of intra-coded picture frames (I-frames) and predicted picture frames (P-frames). The first enhancement layer bitstream may also include a plurality of bi-predictive picture frames (B-frames). The first base layer bitstream may provide the first multimedia content according to a first format, where a format refers to at least one of a quality, resolution, frame rate, bit depth, or multi-view characteristic. However, the first base layer bitstream in combination with the first enhancement layer bitstream provides the first multimedia content according to a second format, where the second format improves at least one characteristic of the first format. The first base layer bitstream transmission and the first enhancement layer bitstream transmission may have co-extensive coverage regions. In one example, the first base layer bitstream and the first enhancement layer bitstream may be received over a forward link only distribution network.

Additionally, the first multimedia content further may include a second enhancement layer bitstream that enhances a display characteristic achievable by the first base layer bitstream in combination with the first enhancement layer bitstream where such display characteristic refers to at least one of a quality, resolution, frame rate, bit depth, or multi-view characteristic. The second enhancement layer bitstream may be received over the second carrier frequency.

According to an additional aspect, a second base layer bitstream may be received over a third carrier frequency. A second enhancement layer bitstream may be received over the second carrier frequency such that the second carrier frequency is shared by enhancement layer bitstreams of different multimedia content (e.g., content for different content channels). A second multimedia content may be reconstructed by combining the second base layer bitstream and the second enhancement layer bitstream.

Similarly, a receiver device is provided comprising a communication circuit and/or a processing circuit. The communication circuit may be configured to receive a first base layer bitstream over a first carrier frequency and receive a first enhancement layer bitstream over a second carrier frequency. The processing circuit may be adapted to reconstruct a first multimedia content by combining the first base layer bitstream and the first enhancement layer bitstream. The processing circuit is further adapted to provide the reconstructed first multimedia content to at least one of a display device, a storage device, or an external playback device. The first base layer bitstream may provide the first multimedia content according to a first format, where a format refers to at least one of a quality, resolution, frame rate, bit depth, or multi-view characteristic. However, the first base layer bitstream in combination with the first enhancement layer bitstream may provide the first multimedia content according to a second format, where the second format improves at least one characteristic of the first format. The first multimedia content further includes a second enhancement layer bitstream that enhances a display characteristic achievable by the first base layer bitstream in combination with the first enhancement layer bitstream where such display characteristic refers to at least one of a quality, resolution, frame rate, bit depth, or multi-view characteristic.

According to an additional aspect, the communication circuit may be further configured to receive a second base layer bitstream over a third carrier frequency and receive a second enhancement layer bitstream over the second carrier frequency such that the second carrier frequency is shared by a enhancement layer bitstreams of different multimedia content. A second multimedia content may be reconstructed by combining the second base layer bitstream and the second enhancement layer bitstream.

### BRIEF DESCRIPTION OF THE DRAWINGS

The features, nature, and advantages of the present features may become more apparent from the detailed description set forth below when taken in conjunction with the drawings in which like reference characters identify correspondingly throughout.

FIG. 1 is a block diagram illustrating how audio/video content may be collected and/or distributed in various resolutions as according to bandwidth and/or resolution of displaying devices.

FIG. 2 illustrates an example of a how video content may be coded into a base layer an enhancement layer.

FIG. 3 illustrates a wireless network that may broadcast a video bitstream coded using a base layer and enhancement layer within a single carrier frequency.

FIG. 4 illustrates a plurality of transmission modes that may be supported in a MediaFLO distribution network according to one example.

FIG. 5 is a block diagram illustrating an exemplary MediaFLO transmitter device.

FIG. 6 illustrates an exemplary MediaFLO distribution network where a transmitter uses a single carrier frequency f1 to broadcast hierarchically encoded content as a base layer and an enhancement layer.

FIG. 7 illustrates a wireless network that may broadcast a multimedia bitstream coded using a base layer and enhancement layer within multi-carrier frequencies.

FIG. 8 illustrates a transmitter device and a receiver device for a wireless communication system capable of supporting multiple frequency carriers that facilitate improved scalability in source coding.

FIG. 9 illustrates an exemplary MCSB network where a transmitter uses different carrier frequencies to broadcast content encoded as a base layer and enhancement layer.

FIG. 10 illustrates a block diagram of a transmitter device in which performance of the enhancement layer in an existing single-carrier network is improved by using an additional enhancement layer carrier.

FIG. 11 illustrates a block diagram of a receiver device in which performance of the enhancement layer in an existing single-carrier network is improved by using an additional enhancement layer carrier.

FIG. 12 illustrates a block diagram of a transmitter device in which performance of the enhancement layer may be achieved by elimination of hierarchical modulation in single carrier frequency systems.

FIG. 13 illustrates a first configuration for transmitting multimedia content as a base layer and one or more enhancement layers over different carrier frequencies to eliminate hierarchical modulation.

FIG. 14 illustrates a second configuration for transmitting multimedia content as a base layer and one or more enhancement layers over different carrier frequencies.

FIG. 15 illustrates a block diagram of a receiver device in which performance of the enhancement layer in an existing single-carrier network is improved by using an additional enhancement layer carrier.

FIG. 16 illustrates an example of how one or more enhancement layer data transmissions may be localized using beam-forming.

FIG. 17 illustrates another example of how one or more enhancement layer data transmissions may be localized using beam-forming.

FIG. 18 is a block diagram of an example of a transmitter device configured to transmit scalable multimedia content over a plurality of carrier frequencies in a forward link only network.

FIG. 19 is a diagram illustrating a method operational in a transmitter device to facilitate scalable multimedia content coding, modulation, and/or delivery over a multi-carrier transmission system.

FIG. 20 is a block diagram of an example of a receiver device configured to receive scalable multimedia content over a plurality of carrier frequencies in a forward link only network.

FIG. 21 is a diagram illustrating a method operational in a receiver device to facilitate scalable multimedia content reception, demodulation, and/or decoding scalable multimedia content transmitted over a multi-carrier transmission system.

### DETAILED DESCRIPTION

In the following description, specific details are given to provide a thorough understanding of the embodiments. However, it will be understood by one of ordinary skill in the art that the embodiments may be practiced without these specific detail. For example, circuits may be shown in block diagrams in order not to obscure the embodiments in unnecessary detail. In other instances, well-known circuits, structures and techniques may not be shown in detail so as not to obscure the embodiments.

In the following description, certain terminology is used to describe certain features of one or more embodiments. For instance, the term “multimedia content” may refer to video, audio, text, graphics and/or a combination thereof and/or associated metadata. The term “bitstream” may include sequences, streams, frames, and/or packets of data, symbols, bits, and/or bytes. The terms “program channel” and/or “content channel” may be interchangeably used to refer to logical and/or program channels that carry a particular multimedia program (e.g., television program, movie, etc.). The terms “transmission channel” and/or “carrier frequency” may refer to physical or logical channels through which one or more program or content channels may be transmitted.

### Overview

A wireless distribution system is provided where multiple carrier frequencies/channels are used to facilitate transmission of scalable multimedia content. In such a system, some carrier frequencies may be assigned to carry base layer (BL) data for one or more program/content channels and some other carrier frequencies may be assigned to carry data for one or more enhancement layers (EL) associated with the base layer data of one or more program/content channels. Additionally, the enhancement layer carrier (ELC) frequency may be shared among program/content channels transmitted over multiple different base layer carrier (BLC) frequencies. While the base and enhancement layers may be scalable coded, other types of coding are contemplated herein. For instance, the enhancement layer may simply be a refinement of the base layer content in some regard (e.g., enhancement layer may simply be overlay information on top of base layer video).

Different numbers of enhancement layers and their bandwidth (or bitrate) may correspond to different quality levels (e.g., resolution, etc.) of the multimedia content. Trade-offs are possible between the number of enhancement layers or program channels carried in the enhancement layer carrier frequency and quality levels of the reconstructed program channels. Enhancement layer coverage depends on coverage of the ELC which can be varied independent of the BLC. Hence tradeoffs are possible between quality of program/content channel and enhancement layer coverage (which may depend on transmit power, modulation schemes, link margin, SNR/PER of the ELC).

Note that while examples described herein may use hierarchical modulation schemes for purposes of illustrating various features, it should be clear that such features are also applicable to (and/or in combination with) various types of modulation schemes, such as Orthogonal Frequency Division Multiplexing (e.g., implemented in (Digital Video Broadcasting Terrestrial systems), quadrature phase-shift keying (QPSK), quadrature amplitude modulation (QAM) among others. Additionally, it should be clear that one or more features described herein may be implemented in a mobile broadcast network, such as (for example) a Forward Link Only (FLO) network, a Digital Video Broadcasting-Handheld (DVB-H) network, an Integrated Services Digital Broadcasting-Terrestrial (ISDB-T)-compatible network, a Satellite Digital Multimedia Broadcasting (S-DMB)-compatible network, an Advanced Television Systems Committee-Mobile/Handheld (ATSC-M/H)-compatible network, among other types of networks.

### Exemplary Audio/Video Distribution System Using Scalable Coding

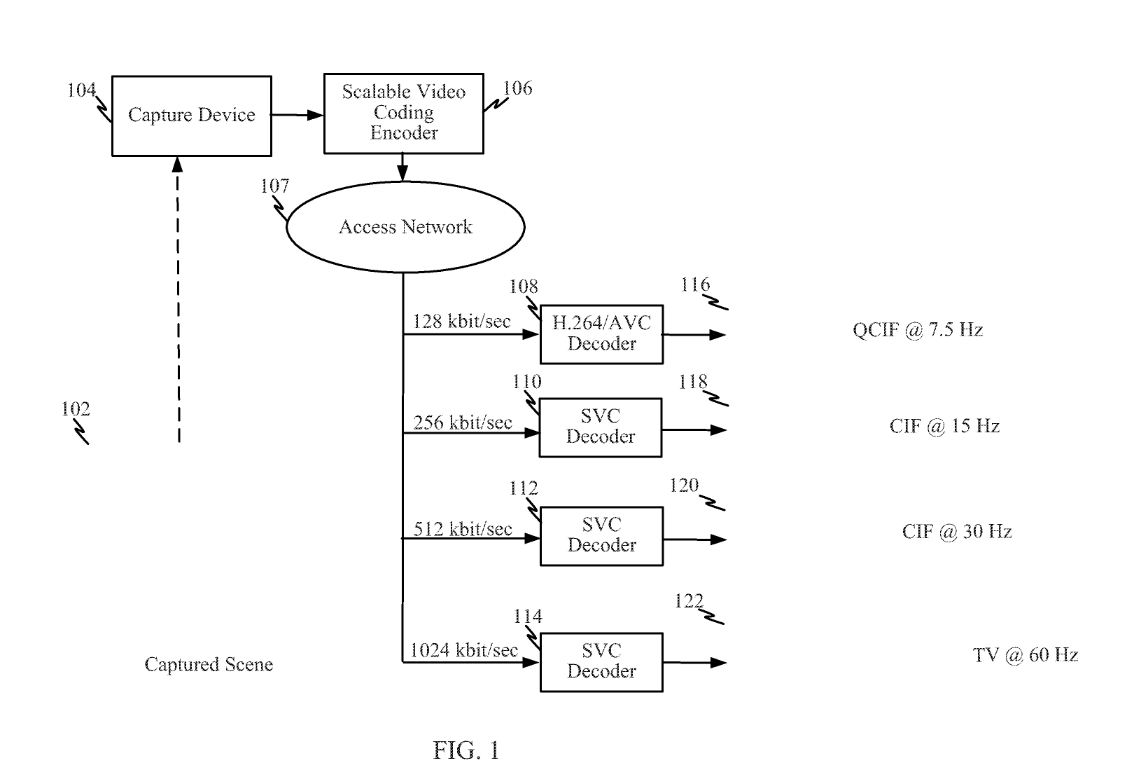

FIG. 1 is a block diagram illustrating how audio/video content may be collected and/or distributed in various resolutions as according to bandwidth and/or resolution of displaying devices. In this example, audio and/or video of a scene 102 may be recorded or captured by a capture device 104 (e.g., digital camera, video camera, etc.) and processed by a scalable video coding (SVC) encoder 106. The encoded content may then be transmitted over an access or distribution network 107 (e.g., internet, wireless network, etc.) according to various quality levels or resolutions. At each receiving device, a decoder 108, 110, 112, and 114 may decode the encoded content to reproduce display content 116, 118, 120, and 122 of varying resolutions.

Scalable Video Coding (SVC) enables encoding of a high-quality video bitstream that contains one or more subset bitstreams. A subset bitstream can represent (separately or in combination) a lower spatial scalability/resolution, lower temporal scalability/resolution, and/or a lower quality video signal scalability/resolution as compared to the original high-quality video bitstream. In temporal scalability, the frame rate may be adjusted to fit the bandwidth/bitrate by, for example, dropping certain frames from the original high-quality video bitstream so that content is displayed at a lower frame rate (e.g., 7.5 frames/second, 15 frames/second, or 30 frames/second). In spatial scalability, the size of an image may be adjusted, for example, by coding the high-quality video bitstream at multiple spatial resolutions (e.g., Quarter Common Intermediate Format (QCIF), CIF, Phase Alternate Line (PAL) television format, TV). In quality scalability, the original high-quality video bitstream may be coded at a single spatial resolution but at different qualities (e.g., different signal-to-noise ratios, fidelities, etc.). Bit-stream scalability for video is a desirable feature for many multimedia applications. The need for scalability arises from graceful degradation transmission requirements, or adaptation needs for spatial formats, bit rates and/or power requirements. To fulfill these requirements, it is beneficial that video is simultaneously transmitted or stored with a variety of spatial or temporal resolutions or qualities which is the purpose of video bit-stream scalability.

Modern video transmission and storage systems using the Internet and mobile networks are typically based on a real-time transport protocol (RTP) or internet protocol (IP) for delivering video content in packet services and on computer file formats (e.g., MPEG-4or 3GP). Most RTP/IP networks are typically characterized by a wide range of connection qualities and receiving devices. The varying connection quality results from adaptive resource sharing mechanisms of these networks addressing the time varying data throughput requirements of a varying number and/or type or receiving devices. The variety of receiving devices (end-points) with different capabilities ranging from cell phones with small screens and restricted processing power to standalone devices with high-definition displays results from the continuous evolution of these end-point devices. Scalable video coding is one solution for delivering video content over distribution networks having different transmission characteristics to various types of receiving devices having different display capabilities.

One type of content delivery network (e.g., a MediaFLO distribution network) may be a single carrier broadcast network based on a Forward Link Only (FLO) physical layer that operates in the Ultra High Frequency (UHF) band (e.g., approx. 700 MHz center frequency). In order to enable graceful degradation at the edge of a coverage region, FLO supports hierarchical modulation where high priority data is transmitted with higher power than low priority data. In addition, a more robust Quadrature Phase Shift Keying (QPSK) modulation is used for high priority data as compared to 16-Quadrature Amplitude Modulation (QAM) for low priority data. In order to exploit scalability (in coverage and channel SNR) offered by hierarchical modulation, application layer data, particularly coded video data may be scaled into base and enhancement layers. The characteristics of video scalability such as number of layers, base to enhancement layer bit rate ratio (B:E), type of scalability (temporal, spatial, quality) and/or visual quality may be designed to correspond to the base-to-enhancement layer energy ratio, modulation schemes, rates of inner code and outer code (Reed-Solomon Code) in the physical and/or Media Access Control (MAC) layer protocols.

Video coding may result in compression of source (raw) video data into bitstreams and compression ratios on the order of, for example, 40:1 to 1000:1 due to the inherent spatial and temporal redundancy in video data. In single layer coding, a single bitstream comprising a stream of variable length codewords may be encapsulated in a packetization format, such as Network Abstraction Layer unit (NALU) in H.264. Several NALUs correspond to a series of slices and/or pictures of the video sequence. Various types of scalability (temporal, spatial, and/or quality) may be introduced in video coding that result in a given video sequence being coded into multiple (one or more) bitstreams.

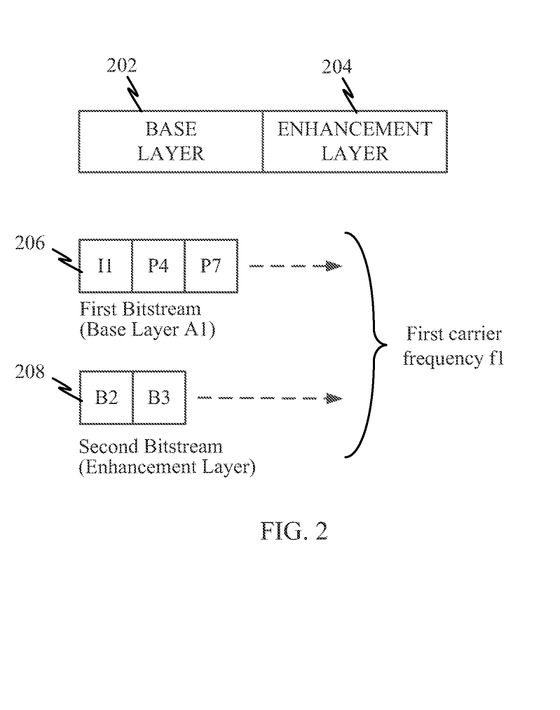

FIG. 2 illustrates an example of a how multimedia (e.g., video) content may be coded into a base layer 202 an enhancement layer 204. A first bitstream 206 may be referred to as the base layer (BL) bitstream. The second bitstreams 208 may be referred to as the enhancement layer 204 (EL) bitstream. There may be one or more base and enhancement layer bitstreams. The enhancement layer bitstream(s) may be dependent on the base layer bitstream(s) for decoding.

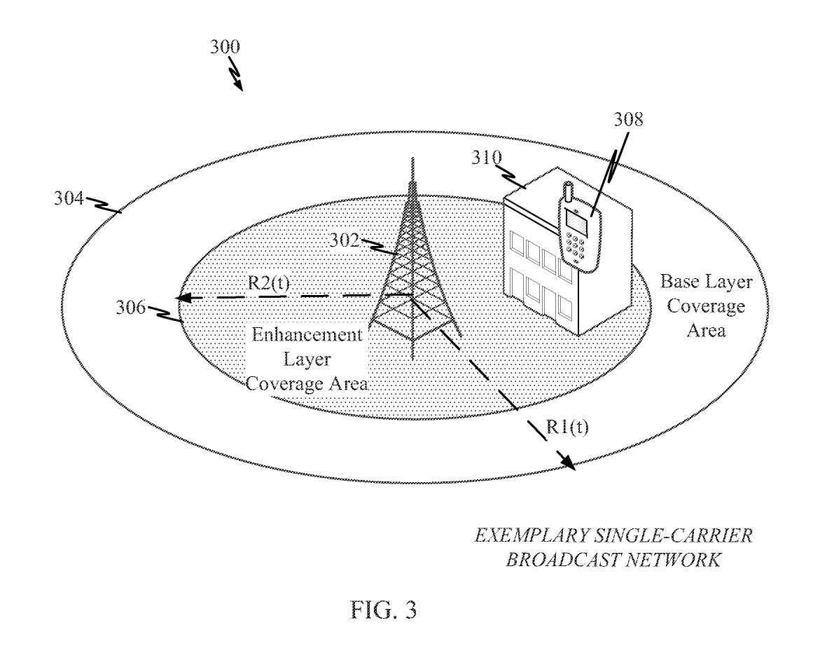

FIG. 3 illustrates a wireless network that may broadcast a video bitstream coded using a base layer and enhancement layer within a single carrier frequency. Such video bitstream may be coded as a base layer (202 in FIG. 2) and an enhancement layer (204 in FIG. 2) corresponding to, for example, Quarter Video Graphic Array (QVGA) resolution (e.g., 320×240 pixel resolution) at up to thirty (30) frames/second. The video bitstream may be broadcasted by a forward link only transmitter 302 to one or more receiving devices 308 within a coverage area. In this example, the video bitstream base layer may extend to a first coverage area 304 (e.g., having a first radius R1(t)) while the enhancement layer may extend to a second coverage area 306 (e.g., having a second radius R2(t), where R2(t)>R1(t)), where the enhancement layer coverage area 306 is within (or a sub-region of) the base layer coverage area 304.

In the example of a typical MediaFLO distribution network, temporal scalability has been adopted for video bitstreams distribution. Since spatial scalability is not used in a typical MediaFLO distribution network, the reconstructed video data at the receiver device 308 results in QVGA video at different frame rates depending on whether the enhancement layer is received by the receiver device 308 or not. The performance of the enhancement layer with respect to coverage and packet error rate (PER), particularly due to in-building penetration losses, often falls short of user expectations. For instance, signal degradation within a building 310 located within the enhanced layer coverage area 306, may prevent the receiver device 308 from receiving enhancement layer information for the video bitstream, thereby degrading the received video content. In addition, error protection offered by the outer code at the edge of the enhancement layer has a short roll-off (e.g., cliff like performance) due to the sudden and significant drop in signal-to-noise ratio (SNR). This may result in a less than graceful degradation of packet error rate (PER) which makes it difficult for the application layer on the receiver device 308 to keep up with such drastic changes to provide the video content. For example, the PER for the enhancement layer may increase from less than 0.5% to more than 20% at the edge of coverage (5 dB SNR drop). This results in an abrupt change in the frame rate of the observed video at the receiver device 308.

Mobile television technologies, including MediaFLO and Digital Video Broadcasting Handheld (DVB-H), are often limited to QVGA resolution video in order to accommodate as many program (content) channels as possible in a 6 MHz (6 Mbps) frequency spectrum. However, a significant proportion of mobile devices have bigger and better displays (VGA, WVGA resolution on mobile phones and WXGA and up on smart phones, mobile internet devices (MID's) or personal digital assistants (PDA's)). Increasing consumer demand for MID's (mobile internet devices) due to proliferation of mobile wireless local area networks (WLAN) and mobile TV in vehicles/automobiles demand higher quality of user experience including higher resolution video (e.g., VGA and WVGA) and/or multi-channel audio. Mobile TV is one such application where, due to the nature of broadcast, it is desirable to cater to receiver devices having different and/or varying display capabilities, processing power resources, and/or communication bandwidths, software versions, etc. Hence, backward compatibility to continue servicing the existing and/or installed base of receivers (for an arbitrary number of years depending on the business model) would also be desirable.

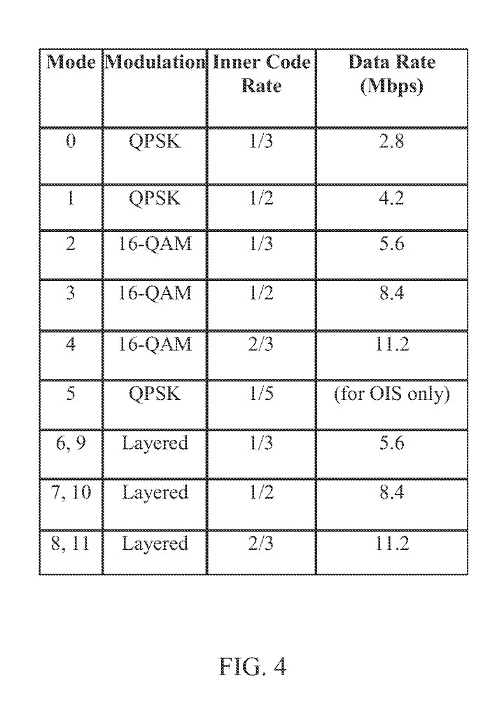

FIG. 4 illustrates a plurality of transmission modes that may be supported in a MediaFLO distribution network according to one example. Mode 1 and Mode 7 may be predominantly used for non-layered and/or layered modes, respectively, for content transmissions. Non-layered modes (i.e., modes 0 to 5) may use Quadrature Phase Shift Key (QPSK) or 16-Quadrature Amplitude Modulation (QAM). In layered modulation modes (e.g., modes 6 to 11), base and enhancement layers are expected to have identical data rates. This is because, each symbol in 16-QAM constellation comprises 2-bits for base layer components and 2-bits for enhancement layer components. This is a major constraint for scalable video coding. Ensuring that the bitrate for base and enhancement layers are the same (i.e., 1:1 ratio) demands tight bitrate tolerance through efficient rate control (to avoid overhead due to stuffing bits to match the ratio). In addition, different types of scalability present different levels of granularity in bitrate. In practice, use of layered modulation modes (e.g., modes 6 to 11) is rather difficult and achieves limited performance improvement due to the interference between the base layer transmissions and the enhancement layer transmissions. Because the base layer transmissions are complete representations of the transmitted content, they are favored over the enhancement layer transmissions. Thus, as illustrated in FIG. 3, in order to maintain a certain minimum signal quality for the base layer transmissions, the base layer is transmitted at a higher energy level than the enhancement layer transmissions. Hence, data transmission over the enhancement layer uses a low transmission energy relative to the higher transmission energy of the base layer.

In the field of video compression, a video frame may be compressed using different algorithms called picture types or frame types. The three major picture types used in the different video algorithms are I, P and B. An I-frame is an Intra-coded picture, in effect a fully-specified picture, like a conventional static image file. I-frames are the least compressible but do not require other video frames to decode. A P-frame, also known as a Predicted picture, holds only the changes in the image from the previous frame. That is, P-frames can use data from previous frames to decompress and are more compressible than I-frames. A B-frame, also know as Bi-predictive picture, saves even more space by using differences between the current frame and both the preceding and following frames to specify its content. That is, B-frames can use both previous and forward frames for data reference to get the highest amount of data compression. Because, P-frames and B-frames hold only part of the image information, they use less space to store a picture or video content than an I-frame, and thus improve video compression rates.

Video (multimedia) encoding using a base layer and enhancement layer may utilize I, P, and/or B frames for compression. For example, temporal scalability may use I and P frames in the base layer and B-frames in the enhancement layer, wherein base layer may provide QVGA @ approx. 10 frames per seconds (fps) while the base plus enhancement layers may provide QVGA @ 30 fps results in a base layer bitrate of 70% of the total base-plus-enhancement layer bitrate. In accommodating temporal scalability within the 1:1 ratio constraint, the total bitrate (base-plus-enhancement layer) ends up at 140% of total bitrate with the enhancement layer padding of 40%, which is the scalability overhead. Hence, a 1:1 ratio for the base to enhancement layer ratio (B:E) does not fit well for temporal scalability.

In the case of spatial scalability, where the base layer may provide QVGA resolution reconstructed video content at the receiver device while the enhancement layer may serve to enhance or improve such QVGA resolution to a VGA resolution, a different base layer to enhancement layer (B:E) ratio may be used. Although the ratio of number of pixels for QVGA:VGA is 1:4, due to higher spatial correlation in VGA, the bitrate ratio used is more on the order of 3:1 and can be reduced to 2:1 depending on quality requirements. One possible method for achieving this is by using configuration transmission parameters to achieve 1 bit/sec/Hz on the base layer and 3 bit/sec/Hz on the enhancement layer. When using hierarchical (layered) modulation, this may be impractical from an implementation perspective since the enhancement layer would have to use 64-QAM, and that would mean the analog-to-digital (A/D) requirements on the radio frequency (RF) section would be similar to having a single 256-QAM stream (approximately) which requires more complex circuitry in the receiver which makes this nearly impossible for mobile devices (or drives up the cost of the receiving device).

Therefore, the ability to adapt the enhancement layer bitrate (e.g., bandwidth required) independent of base layer bitrate and varying the type of scalability depending on the targeted subscribers, quality-of-service, tiers of service, etc., may improve the overall performance of an over-the-air video content delivery service significantly. Facilitating the enhancement layer to be transmitted on a separate carrier and adapting the transport and transmission parameters independent of the base layer using a multi-carrier scalable system may provide all of these improvements and more. The enhancement layer can utilize lower order modulation schemes such as QPSK or 16-QAM and does not have to be transmitted on a higher order modulation, thereby removing the need for complex RF section in receiving devices.

MediaFLO access networks (a type of forward-link only network) have been designed such that base layer defines the coverage and the system is optimized for base layer performance. For example, the energy ratio for base to enhancement layers is 4:1, where 80% of the transmitted energy (e.g., energy for the base layer transmission) is expected to reach the edge of a cell coverage area. Hence, data transmission over the enhancement layer uses relatively low transmission energy, and enhancement layer performance is achievable at high signal-to-noise ratios (SNR).

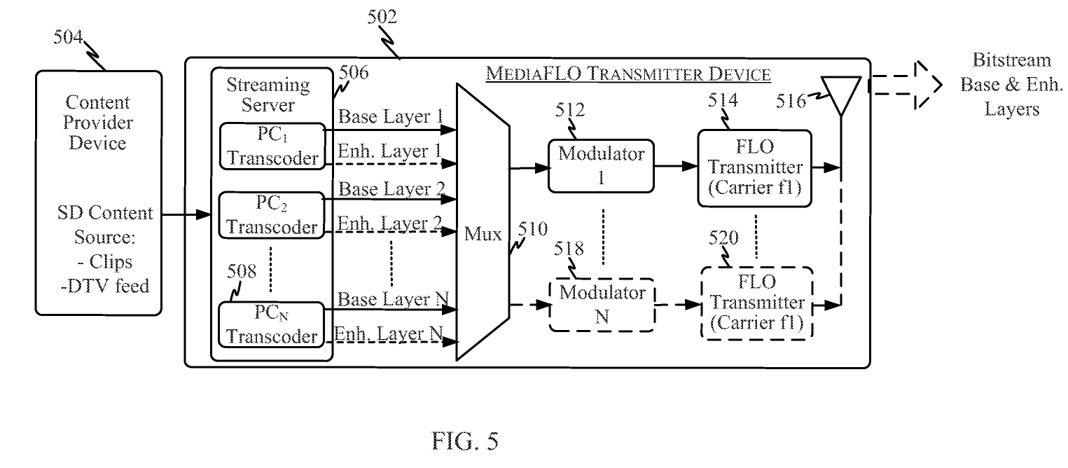

FIG. 5 is a block diagram illustrating an exemplary MediaFLO transmitter device. The transmitter device 502 may receive standard definition (SD) multimedia content from a content provider device 504. Such multimedia content may include, for example, video content from various content providers and/or program/content channels in the form of video clips and linear feeds from terrestrial Digital Television feeds. The transmitter device 502 may include a stream server 506, a multiplexer 510, a plurality of modulators 512 and 518, a plurality of single-carrier transmitters 514 and 520, and corresponding antenna 516.

The streaming server 506 may include a bank of audio-video transcoders 508, one for each program/content channel (PC) that process the incoming multimedia content from the content provider device 504 to convert an incoming multimedia content data stream/bitstream from a first format to a second (compressed) format. In doing so, the transconders 508 may perform non-layered modulation (e.g., modes 0 to 5 in FIG. 3) or layered modulation (hierarchical modulation) (e.g., modes 6 to 11 in FIG. 3). When implementing hierarchical modulation, the transcoders 508 may convert the incoming multimedia content bitstreams into, for example, scalable output data streams/bitstreams comprising base layer data streams/bitstreams and enhancement (Enh.) layer data streams/bitstreams. In one example, each transcoder 508 may comprise an MPEG-2 decoder, a pre-processor, and/or enhanced H.264 encoder. Video processing may include decoding a received MPEG-2 coded video elementary bitstream, pre-processing the decoded bitstream for de-interlacing and de-noising and down-sampling them to QVGA resolution. The enhanced H.264 encoder compresses the QVGA video content into H.264 coding format, inserts channel switch frames (I-slices) and encodes I and P slices into a base layer bitstream and encodes B slices into one or more enhancement layer bitstreams, thus achieving temporal scalability.

The multiplexer 510 multiplexes the plurality of output data streams/bitstreams (e.g., application layer data flows) from the streaming server 506 into corresponding MediaFLO logical channels (MLCs) for transmission over a FLO physical layer data channel. The MFLO modulator 512 or 518 may be configured to carry either single layer coded multimedia (e.g., audio-video data) content when using non-layered modulation modes and MLCs containing 2-layer scalable coded video data when using layered (hierarchical) modulation modes. The FLO transmitters 514 and 520 may then transmit all MLCs over a single carrier frequency (e.g., Carrier f1).

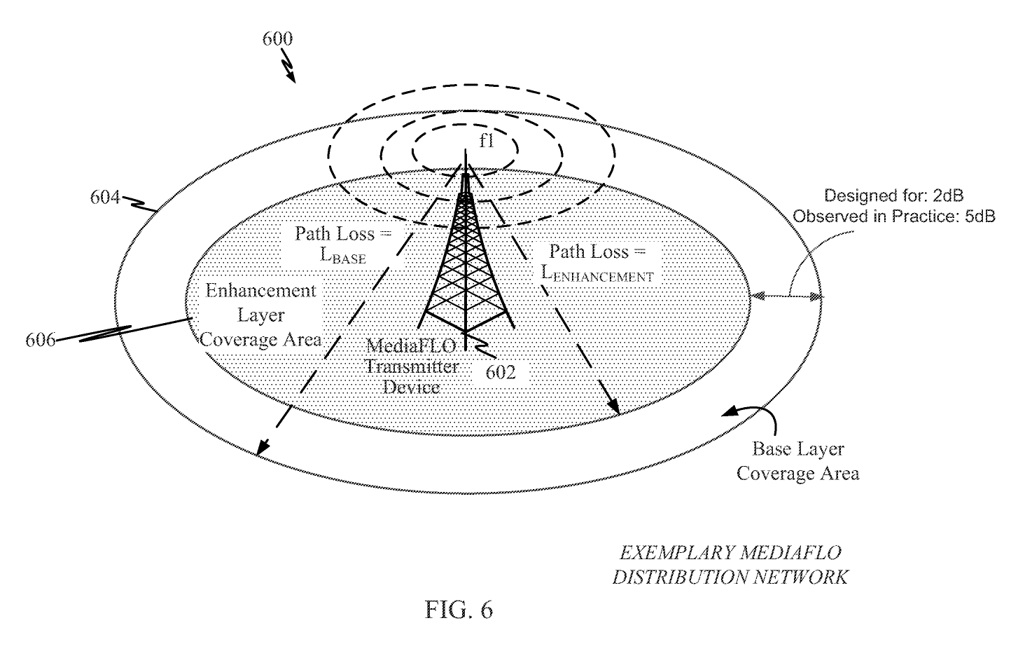

FIG. 6 illustrates an exemplary MediaFLO distribution network 600 where a transmitter device 602 uses a single carrier frequency f1 to broadcast hierarchically encoded content as a base layer and an enhancement layer. The MediaFLO distribution network may be designed for a 2 dB difference in SNR between the edge of a base layer coverage area 604 and the edge of an enhancement layer coverage area 606, and the edge of coverage is targeted for 1% PER. However, the observed performance in the field for layered modes is on the order of a 5 dB difference between the base layer coverage area 604 and the enhancement layer coverage area 606.

The enhancement layer may be highly sensitive to the RF noise floor and hence may not be properly received (or decodable) under severe fade conditions and may be severely impacted by in-building penetration. This severely impacts average base layer plus enhancement layer coverage area for MediaFLO networks, noticeably in terms of the received video frame rate. As previously noted, the base layer performance of MediaFLO is QVGA at 10 frames per second, which is less than satisfactory given the ever increasing resolution and display capabilities of newer receiver devices and increased availability of content at larger resolution. Up-sampling QVGA to VGA alone is insufficient to provide acceptable video quality given the lower frame rate and accentuation of artifacts in the process. Hence, improving video content delivery is hereby shifted from optimizing just the base layer to improving base layer plus enhancement layer performance. In order to facilitate this shift, the enhancement layer coverage area is extended to be approximately co-extensive with the base layer coverage area.

To address the shortcomings of such single carrier networks with hierarchical modulation (i.e., not just for forward link only networks but also Digital Video Broadcasting-Handheld DVB-H networks as well as other broadcast networks), a multi-carrier scalable broadcast (MCSB) system is provided. At least two approaches are described herein: (a) augmenting existing single-carrier systems, and (b) eliminating hierarchical modulation by using a multi-carrier scalable broadcasting system.

Augment Existing Single-Carrier System: On feature provides for improving performance of the enhancement layer in an existing single-carrier network by using an additional enhancement layer carrier (ELC). This may be done using existing network infrastructure such as transmission towers, by overlaying the enhancement layer carrier signal on top of the existing single-carrier transmission (e.g., MediaFLO network transmission) while expanding or extending the enhancement layer coverage area to be substantially co-extensive with the base layer coverage area.

Eliminating Hierarchical Modulation: Another feature provides for converting an existing hierarchical modulation transmission system (e.g., layered modulation) to an all non-layered transmission system where only the base layer data is transmitted over a first carrier frequency while the enhancement layer data is transmitted over a second carrier frequency by using non-layered modes independent of the base layer modes.

### Exemplary Multi-Carrier Transmission System For Scalability In Source Coding

The features of (a) augmenting existing single-carrier systems and (b) eliminating hierarchical modulation rely on switching from a single carrier system to a multi-carrier scalable broadcast (MCSB) system. According to various examples, these features may be implemented in a mobile broadcast network, such as (for example) a Forward Link Only (FLO) network, a Digital Video Broadcasting-Handheld (DVB-H) network, an Integrated Services Digital Broadcasting-Terrestrial (ISDB-T)-compatible network, a Satellite Digital Multimedia Broadcasting (S-DMB)-compatible network, an Advanced Television Systems Committee-Mobile/Handheld (ATSC-M/H)-compatible network, among other types of networks.

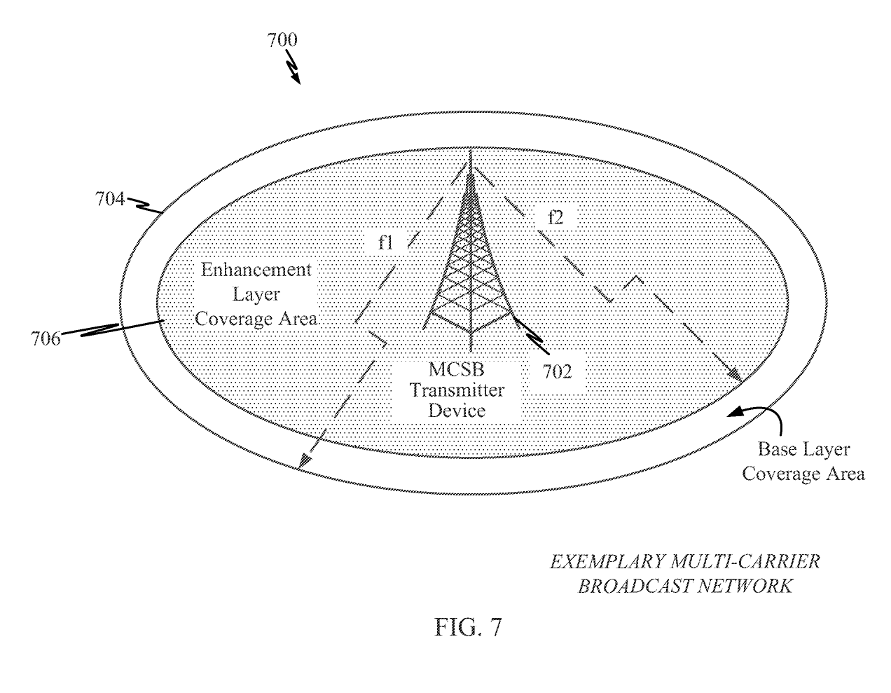

FIG. 7 illustrates a wireless network that may broadcast a multimedia bitstream coded using a base layer and enhancement layer within multi-carrier frequencies. In this example, a multi-carrier scalable broadcast (MCSB) network 700 may include a MCSB transmitter device 702 that may transmit video content using scalable bitstreams (e.g., video content is coded as a base layer and an enhancement layer), where the scalable bitstreams are broadcast over different carrier frequencies from the transmitter device 702. As can be perceived from FIG. 7, transmission of the base and enhancement layer information or bitstreams using different frequencies may result in the enhancement layer coverage area 706 extending through a greater portion of the base layer coverage area 704. That is, relative to enhancement layer coverage area 306 illustrated in FIG. 3, using multi-carrier modulation for the enhancement layer allows an enhancement layer coverage area 706 to occupy a greater portion of the base layer coverage area 704.

As noted before, in typical or current implementations of a MediaFLO distribution network, base and enhancement layers are transmitted on the same carrier frequency. The transmissions of different content may be differentiated using different modulation schemes, turbo (inner) code rate, and/or transmit power. However, in a multi-carrier approach, the base and enhancement layers are transmitted on different carrier frequencies.

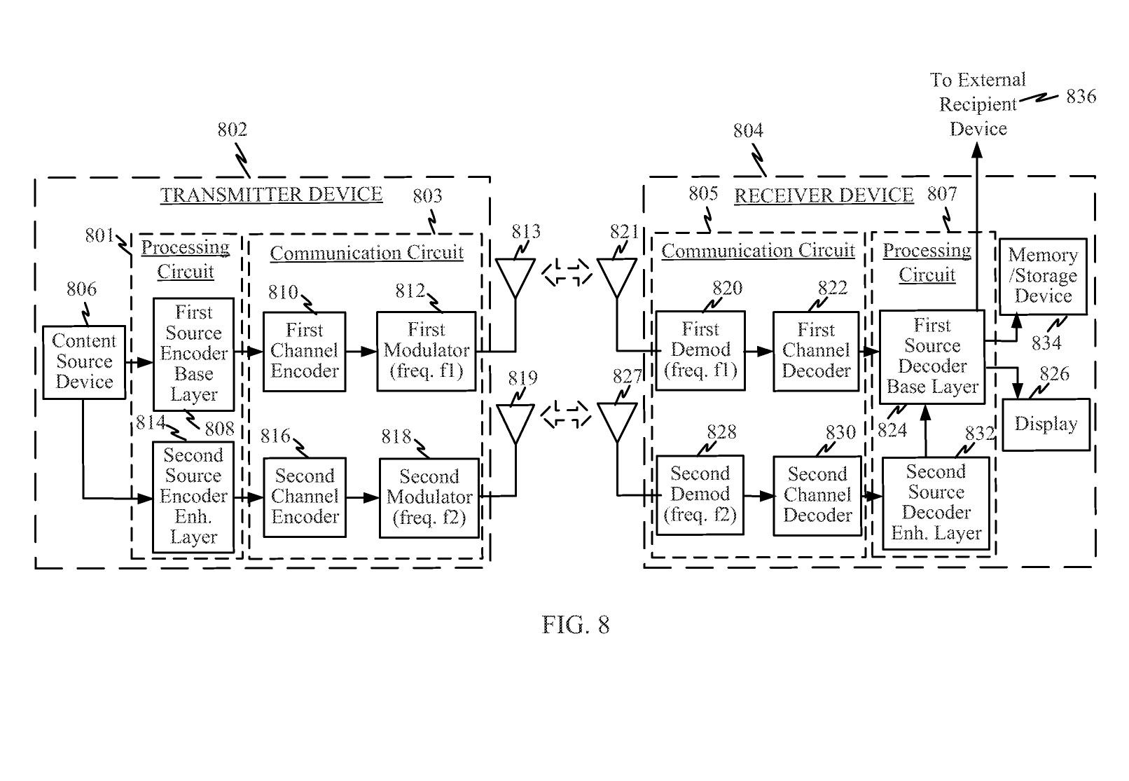

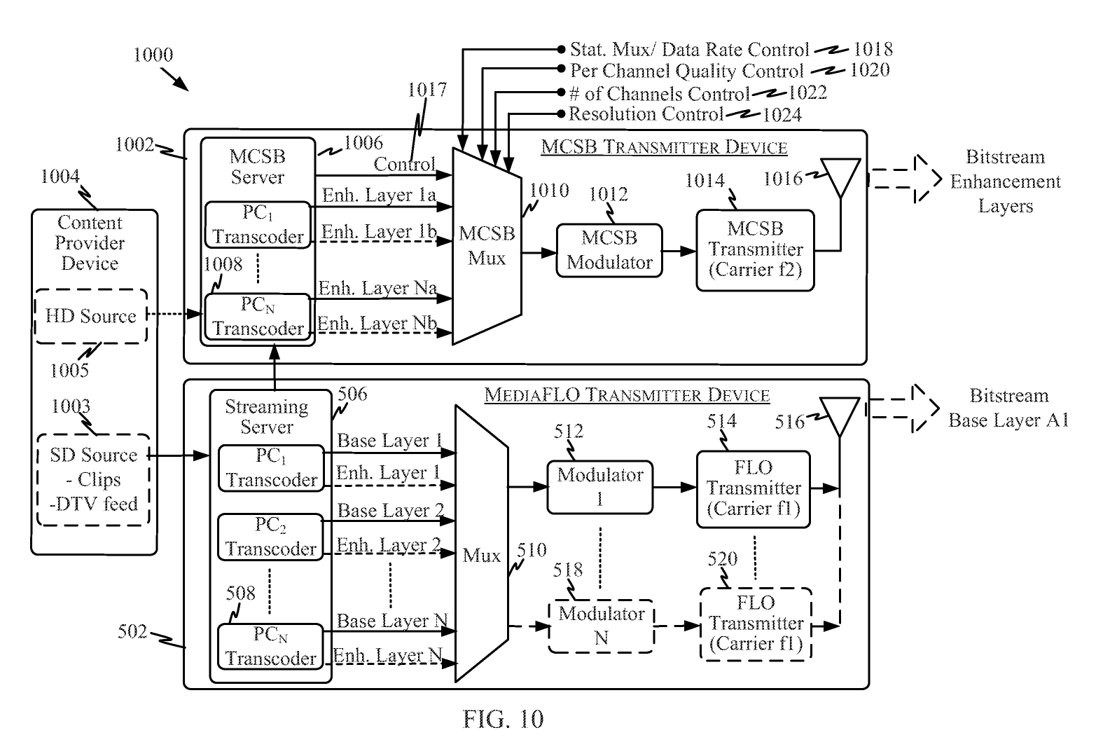

FIG. 8 illustrates a transmitter device and a receiver device for a wireless communication system capable of supporting multiple frequency carriers that facilitate improved scalability in source coding. In this example, base and enhancement layer bitstreams are transmitted on different frequencies, f1 for base and f2 for enhancement. In this example, the transmitter device 802 may comprise a first processing circuit 801 coupled to a first communication circuit 803 to perform encoding and/or modulation functions. For instance, the first processing circuit 801 may perform content encoding functions while the first communication circuit 803 performs channel encoding and modulation functions. Similarly, the receiver device 804 may comprise a second communication circuit 805 coupled to a second processing circuit 807 to perform demodulation and/or decoding functions. For instance, the second communication circuit 805 performs channel demodulation and decoding functions while the first processing circuit 807 may perform content decoding functions. In other implementations, these functions may be performed by a single circuit or a plurality of different circuits. Note that the exemplary implementations illustrated in FIGS. 10, 11, 12, and 15 may similarly include one or more processing circuits and/or one or more communication circuits to perform the operations/functions therein.

The transmitter device 802 may obtain content from a source device 806 and utilize two different transmitter chains to modulate the content in a base layer and an enhancement layer. The content source device 806 may include, for example, a memory device/buffer or external interface from which to obtain and/or receive content (e.g., video content) to be transmitted. A first transmitter chain, comprising a first source encoder 808, a first channel encoder 810, and a first modulator 812 (modulating at carrier frequency f1), may be used to encode and transmit the content in the base layer. A second transmitter chain, comprising a second source encoder 814, a second channel encoder 816, and a second modulator 818 (modulating at carrier frequency f2), may be used to encode and transmit the content in the enhancement layer. Note that the encoded content may be wirelessly transmitted or broadcasted over the same or different antennas 813 and/or 819 to one or more receiver devices.

The receiver device 804 may receive over-the-air content broadcasts and/or transmissions from the transmitter device 802 over the same or different antennas 821 and/or 827. Since the content is encoded and modulated into a base layer and an enhancement layer, the receiver device 804 may include different receiver chains. A first receiver chain, comprising a first demodulator 820 (demodulating at carrier frequency f1), a first channel decoder 822, and a first source decoder 824, may be used to decode the received content in the base layer. A second receiver chain, comprising a second demodulator 828 (demodulating at carrier frequency f2), a second channel decoder 830, and a second source decoder 832, may be used to decode the received content in the enhancement layer. The decoded content from the first and second receiver chains may be combined and output via a display device 826, stored in a memory or storage device 834, and/or sent to an external recipient device 836.

Scalability in source coding, particularly in video coding, involves additional overhead compared to single layer coding of comparable performance in terms of compression efficiency (for a given set of parameters such as resolution, frame rate, etc). In order to minimize this overhead from an end-to-end system throughput perspective, and to minimize overhead associated with distribution and error protection (encapsulation, packetization, security) of multiple layers as compared to single layer bitstream, end-to-end cross-layer optimizations may be used. In particular, network layer transport protocol, the media access control (MAC) layer protocols (e.g., forward error correction (FEC), stream layer encapsulation, etc.) and physical (PHY) layer protocol (inner coding or channel coding rates, modulation schemes, multi-layer coding support and corresponding energy ratios) may be aligned with or adapted to scalability characteristics of source coding to maximize information/bit/Hz for the system.

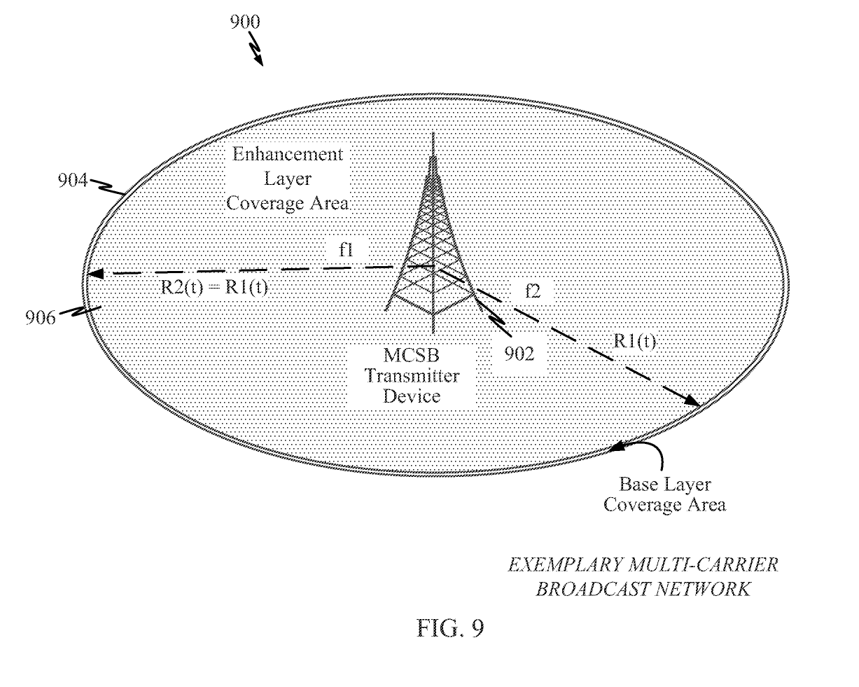

FIG. 9 illustrates an exemplary MCSB network 900 where a transmitter 902 uses different carrier frequencies to broadcast content encoded as a base layer and enhancement layer. As illustrated here, the enhancement layer coverage area 906 is extended to be approximately co-extensive with the base layer coverage area 904. As used herein, the term “co-extensive” means that the base layer and enhancement layer cover or extend over approximately the same region. The base layer is transmitted using a first carrier frequency f1 while the enhancement layer is transmitted using a second carrier frequency f2. Transmitting the enhancement layer on a different carrier frequency than the base layer allows providing video content output at higher resolution. When using a multi-carrier frequency system, the base layer to enhancement layer energy ratio is no longer a factor since the enhancement layer transmit power is independent of the base layer transmit power. The path loss characteristics are independent between the base layer and the enhancement layer and lower order modulation on the enhancement layer improves PER performance and enables a more robust communication path. Additionally, if hierarchical modulation is disabled, the interference that the base layer signal transmission experiences (higher noise floor) from the enhancement layer signal transmission is eliminated, thus improving SNR and the coverage area of base layer. The base layer and enhancement layer carrier frequencies f1 and f2 may be selected to provide a desired amount of frequency separation as required by the service deployed in this configuration which may provide additional interference protection.

The capacity and coverage offered by some single-carrier broadcasting systems (e.g., commercial MediaFLO systems) are illustrated in FIG. 3. In such single-carrier frequency (e.g., Carrier f1—Ultra High Frequency (UHF) Channel 53) broadcasting systems, a base layer data broadcast may have a coverage area 304 (e.g., of first radius R1(t)) while an enhancement layer data broadcast may have a coverage area 306 (e.g., of second radius R2(t)), where R₂(t)<R₁(t). In such single-carrier system at full capacity, using hierarchical modulation, the total throughput that may be achieved is 11.2 Mbps (e.g., from FIG. 3) for a 6 MHz channel. This comprises 5.6 Mbps for base layer data transmissions and 5.6 Mbps for enhancement layer data. At an average of 384 kbps per video content stream, the capacity of such distribution system is approximately thirty (30) program/content channels (e.g., video content distribution channels—ignoring audio and/or overhead data rates for simplicity of calculations). Therefore, the capacity and coverage area for base layer transmissions in a single-carrier frequency (e.g., Carrier f1) broadcasting system may be, for example, thirty (30) program/content channels at up to a radius R1(t). Throughput and number of program channels depend on spectral efficiency of the broadcast system and will be different for different broadcast standards/methods utilized. Some of the examples illustrated herein may relate to, for example, forward-link only (FLO) systems. The capacity and coverage area for the combined base layer and enhancement layer transmissions in the single-carrier frequency (e.g., Carrier f1) broadcasting system may be, for example, thirty (30) program/content channels at up to a radius R2(t), where R₂(t)<R₁(t).

If a similar configuration is replicated using a second carrier frequency (e.g., (e.g., Carrier f2—UHF Channel 55), transmission of up to sixty (60) program/content channels may be achieved at a radius of R1(t) for base layer transmissions while the combined base layer and enhancement layer transmissions may be thirty (30) program/content channels at a second radius of R2(t). Thus, the base layer plus enhancement layer coverage is always limited to the second radius R2(t).

Referring again to FIG. 9, the wireless network 900 may serve to distribute/broadcast video content by using a base layer bitstream and enhancement layer bitstream within multi-carrier frequencies. To overcome the capacity and/or coverage limitations of single-carrier system, a multi-carrier method is herein disclosed to augment single-carrier systems. To achieve this, a first carrier frequency (e.g., Carrier fl) may be used to transmit the base layer data up to a radius R1(t). Then a second carrier frequency (e.g., Carrier f2) is used to transmit the enhancement layer data using a non-layered mode to match the base layer transmission coverage (e.g., radius R1(t)) over the first carrier frequency. Thus, the total capacity and coverage for this augmented configuration for the base layer plus enhancement layer is, for example, thirty (30) program/content channels for up to a first radius R1(t). Additionally a hybrid of these two methods may be used to provide different coverage regions for different applications or services.

The use of a multi-carrier system to separately transmit the enhancement layer (and therefore minimize interference to the base layer), may be used to augment an existing single-carrier system or to eliminate hierarchical modulation altogether.

### Augmenting Existing Single-Carrier System

FIG. 10 illustrates a block diagram of a transmitter device 1000 in which performance of the enhancement layer in an existing single-carrier network is improved by using an additional enhancement layer carrier. The transmitter device 1000 may include a first transmitter device 502 and a second transmitter device 1002. The first transmitter device 502 may be a MediaFLO transmitter as discussed in FIG. 5. In this implementation, a content provider device 1004 may include a standard definition (SD) source 1003 that provides standard definition (SD) content to the first transmitter device 502. Depending on the implementation and video characteristic desired (e.g., a quality, resolution, frame rate, bit depth, and/or multi-view characteristic), the second transmitter device 1002 may obtain or receive enhancement layer data from the first transmitter device 502 and/or a high definition (HD) source 1005. As used herein, the high definition content may be, for example, higher resolution and/or fidelity relative to the standard definition content. The second transmitter device 1002 serves to augment the performance of the first transmitter device 502 by, in addition to the hierarchically modulated content transmission by the first transmitter device 502, utilizing a different carrier frequency to transmit enhancement layer data corresponding to the content transmission by the first transmitter device.

The second (MCSB) transmitter device 1002 may include a MCSB server 1006 comprising a bank of program channel transcoders, a multiplexer 1010, a MCSB modulator 1012, a MCSB transmitter 1014, and an antenna 1016. The MCSB server 1006 may receive high definition content and generate one or more enhancement layer bitstreams (i.e., Enh. Layer 1a, 1b . . . Na, Nb) corresponding to base layer bitstreams generated by the first transmitter device 502. The one or more enhancement layer bitstreams may then be multiplexed, modulated, and transmitted by a second carrier frequency f2. The transmission from the second transmitter device 1002 may be overlaid on top of the existing single-carrier transmission from the first transmitter device 502. This allows expanding or extending the enhancement layer coverage area to be substantially co-extensive with the base layer coverage area.

While the first (MediaFLO) transmitter device 502 alone may be able to provide multimedia content to a distance of R1(t) (for base layer content) and R2(t) (for base layer content and enhancement layer content), where R1(t)>R2(t), the second transmitter device 1002 enhances performance by extending the coverage area for the base layer content and enhancement layer content to at least a distance R1(t). Thus, if the first (MediaFLO) transmitter device 502 alone could provide QVGA resolution multimedia content to a distance of R1(t) (i.e., based on content of the base layer bitstream), the addition of the second transmitter device 1002 may provide VGA resolution content to a distance of R1(t) (i.e., based on content of the enhancement layer bitstream).

According to a first approach to augment an existing FLO transmission system, the second (MCSB) transmitter device 1002 coexists and operates synchronously with the first (MediaFLO) transmitter device 502. The MCSB transcoders 1008 may receive enhancement layer data from MediaFLO transcoders 508 and the MCSB multiplexer 1010 multiplexes the received bitstreams into enhancement layer bitstreams corresponding to MCSB logical channels. The MCSB modulator 1012 transmits the MCSB logical channels (e.g., enhancement layer bitstreams) using a FLO non-layered modulation mode (e.g., modes 0 to 5 in FIG. 4) over a second carrier frequency f2. On the second transmitter device 1002, the transmit power, outer coding method and rate, the channel structure and modulation type and inner code rates may be configured to achieve a desired enhancement layer coverage.

According to a second approach to augmenting an existing FLO transmission system, the MCSB transcoders 1008 may receive high definition (HD) content from the content provider 1004 (and/or other content not originally being transmitted over the first transmitter device 502) and processes the content as enhancement layer information for transmission over the second carrier frequency f2. The MCSB transcoders 1008 may down-sample the high definition (HD) content to WQVGA or WVGA, for example, to retain an aspect ratio at 16:9 and encode the resulting content using, for example, a H.264-compliant advanced video codec or even possibly using an alternative codec. The MCSB multiplexer 1010 may receive control signals 1017 from the MCSB transcoders 1008, and/or multiplexer 510 including statistical multiplex controls 1018 for translating MCSB flows to fit the available bandwidth of the MCSB multiplexer 1010, control information 1020 to adjust quality of experience on a per flow or program channel basis, controls 1022 to change the number of program channels or flow on the MCSB multiplexer 1010, and control information 1024 to change at least one characteristic (e.g., a quality, resolution, frame rate, bit depth, or multi-view characteristic) of encoded data on a per flow basis as defined by the quality of experience or number of channels settings (e.g. if the bandwidth requirement exceeds for a given superframe, the resolution may be lowered from WQVGA to QVGA by dropping 5 columns of macro-blocks, which are padded with black at the decoder at the receiver).

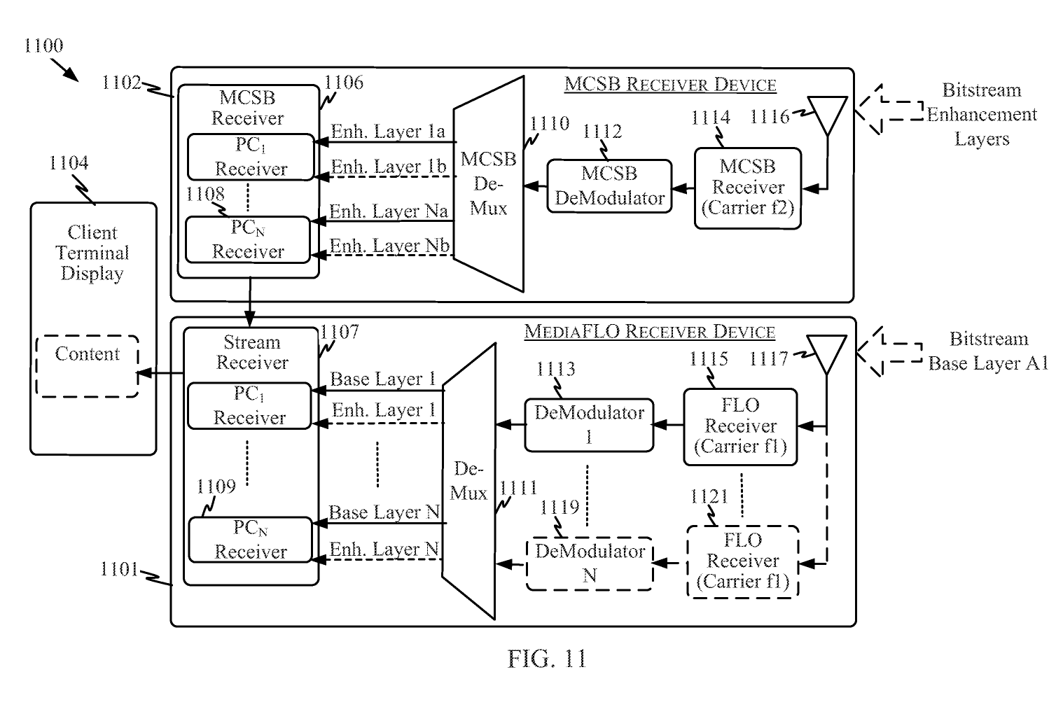

FIG. 11 illustrates a block diagram of a receiver device 1100 in which performance of the enhancement layer in an existing single-carrier network is improved by using an additional enhancement layer carrier frequency. The receiver device 1100 may include a first (MediaFLO) receiver device 1101 and a second receiver device 1102. The first receiver device 1101 may be a MediaFLO receiver. In this implementation, the first receiver device 1101 may include an antenna 1117 and receivers 1115 and 1121 to receive a single-carrier signal transmission (e.g., carrier f1) including hierarchically modulated video content. The received single-carrier signal transmission is demodulated by one or more demodulators 1113 and/or 1119 and demultiplexed by a demultiplexer 1111. The demultiplexer 1111 decomposes the received single-carrier signal transmission into a plurality of MediaFLO logical channels (MLCs), each of which is a program/content channel represented by a base layer bitstream and one or more enhancement layer bitstreams. For each MLC, a program/content channel receiver 1109 captures the base and/or enhancement layer bitstreams (from the second receiver device 1102), reconstructs the corresponding multimedia content channel (e.g., based on the base layer bitstream and/or enhancement layer bitstream) to a desired video format (e.g., quality, resolution, frame rate, bit depth, or multi-view characteristic) which can then be provided to a client terminal display 1104 for display (or to another device for storage).

In order to provide content at an improved quality or characteristic (e.g., quality, resolution, frame rate, bit depth, or multi-view characteristic), the second receiver device 1102 may be a MCSB receiver operating on a second carrier frequency f2 different from the first carrier frequency f1 than the first receiver device 1101. In this implementation, the second receiver device 1102 may include an antenna 1116, a receiver 1114 to receive multi-carrier signal transmissions (e.g., carrier f2) including non-layered video content. In this example, the non-layered video content may be enhancement layer data corresponding to base layer content being received by the first receiver device 1101. The received multi-carrier signal transmission is demodulated by the demodulator 1112 and demultiplexed by a demultiplexer 1110. The demultiplexer 1110 decomposes the received signal transmission into enhancement layer bitstreams corresponding to a plurality of MediaFLO logical channels (MLCs). For each MLC, a program/content channel receiver 1108 captures the enhancement layer stream and provides it to a corresponding receiver 1109 in the first receiver device 1101 which reconstructs the content bitstream to a desired content characteristic (e.g., quality, resolution, frame rate, bit depth, or multi-view characteristic) and provides it to the client terminal display 1104 for display (or to another device for storage).

### Elimination of Hierarchical Modulation

According to yet another feature, the transmitter system illustrated in FIG. 10 may be modified to use only non-layered modes, e.g., mode 2 in FIG. 4. Since only base layer data is transmitted by the first transmitter device 502 using a first carrier frequency f1, up to thirty (30) program/content channels may be supported. The second transmitter device 1002 is used to transmit enhancement layer data over a second carrier frequency f2 using non-layered modes to match base layer coverage over the first carrier frequency f1. Because both the base layer and enhancement layer are transmitted using non-layered modes and over different carrier frequencies f1 and f2, the total capacity and coverage that may be achieved may be, for example, a first set of thirty (30) program content channels up to a distance R1′(t), where R1′(t)>R1(t) of FIG. 9. That is, because the base layer is transmitted using a non-layered mode over a first carrier frequency f1, it is not affected by interference from the enhancement layer which is transmitted over a second carrier frequency f2. Therefore, the coverage area of the base layer is greater (i.e., R1′(t)>R1(t)) than when hierarchical modulation (layered modulation) is used. Additionally, because the enhancement layer data transmission is performed using a non-layered mode, it can match the coverage area of the base layer data transmission.

In yet another implementation, a third carrier frequency f3 may be utilized to transmit another base layer data for a second set of thirty (30) program/content channels up to a distance R1′(t). The second carrier frequency f2 may also be utilized to transmit enhancement layer data for the second set of program content channels. Thus, the total number of program/content channels that may be achieved over the three carrier frequencies f1, f2, and f3 is sixty (60) program/content channels up to a distance R1′(t) and with improved resolution (e.g., VGA). The coverage area the base layers and enhancement layers of the sixty (60) program/content channels is R_{1′}(t), where R_{1′}(t)>R₁(t). This is an improvement of the SNR over hierarchical modulation, improving in-building resolution due to the use of lower order, more robust, modulation schemes. Other combinations of base and enhancement layers across multiple carriers would result in different performance characteristics with respect to number of channels, resolution, coverage, etc., and the distribution of base and enhancement layers and their configuration or properties may be adapted to the desired service or application.

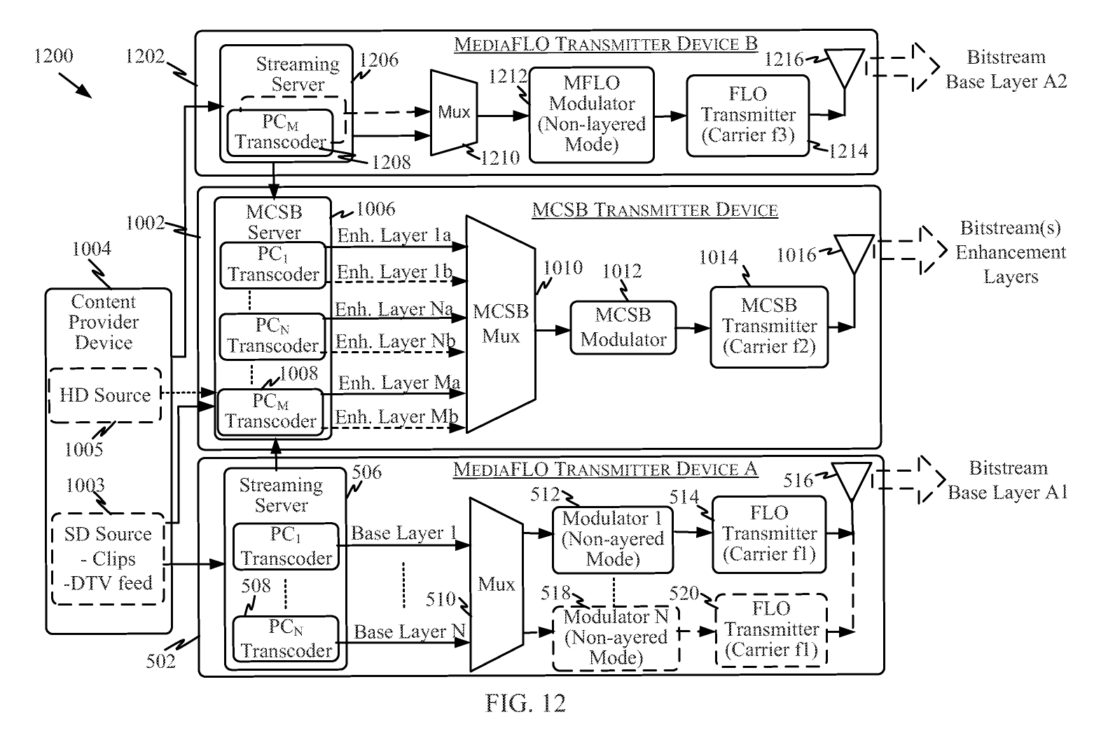

FIG. 12 illustrates a block diagram of a transmitter device 1200 in which performance of the enhancement layer may be achieved by elimination of hierarchical modulation in single carrier frequency systems. The transmitter device 1200 may include a first (MediaFLO) transmitter device 502, a second (MCSB) transmitter device 1002, and a third (MediaFLO) transmitter device 1202. The first transmitter device 502 may operate as previously described except that it is configured to transmit all MLCs using non-layered modes, thus eliminating hierarchical modulation. Such configuration may apply to broadcast technologies that do not support hierarchical modulations. The first transmitter device 502 may transmit base layer content data over a first carrier frequency f1 while providing enhancement layer content data to the second transmitter device 1002. The second transmitter device 1002 then transmits one or more enhancement layer bitstreams over a second carrier frequency f2. For example, depending on the desired quality of service (e.g. frame rate), the B-slices may be coded into an enhancement layer bitstream and sent by the first transmitter device 502 to the second (MCSB) transmitter device 1002 for transmission.

As illustrated herein, content for one or more multimedia content channels is obtained, for example, from the content provider device 1004. The streaming server 506 (e.g., program/content channel transcoders 508) may convert a content of a first multimedia content channel to a scalable format. For instance, the first multimedia content includes a first base layer bitstream (e.g., Base Layer 1) and a first enhancement layer bitstream (e.g., Enh. Layer 1a). The first base layer bitstream may then be transmitted (e.g., after multiplexing at multiplexer 510 and modulation at modulator 512) over a first carrier frequency (e.g., via transmitter 514). Similarly, the first enhancement layer bitstream may be transmitted (e.g., after multiplexing at multiplexer 1010 and modulation at modulator 1012) over a second carrier frequency (e.g., via transmitter 1014).

Additionally, a content of a second multimedia content channel may be converted to the scalable format, where the second multimedia content includes a second base layer bitstream (e.g., Base Layer N) and a second enhancement layer bitstream (e.g., Enh. Layer Na). The first and second base layer bitstreams may then be multiplexed (e.g., by multiplexer 510) to create a first multiplexed bitstream prior to transmission. The first multiplexed bitstream may then be transmitted over a first carrier frequency (via one or more transmitters 514 and 520). Similarly, the first and second enhancement layer bitstreams may be multiplexed (e.g., by multiplexer 1010) to create a second multiplexed bitstream prior to transmission. The second multiplexed bitstream is then transmitted over the second carrier frequency (via transmitter 1014).

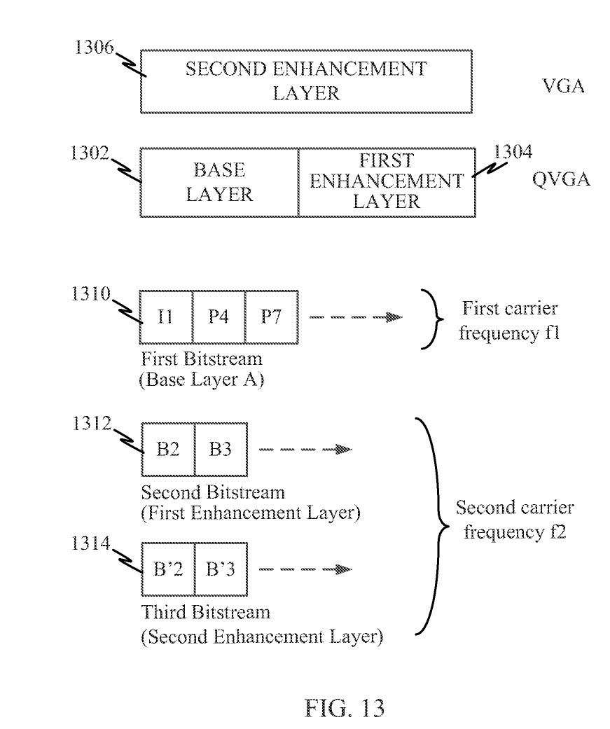

FIG. 13 illustrates a first configuration for transmitting multimedia content as a base layer and one or more enhancement layers over different carrier frequencies to eliminate hierarchical modulation. In this configuration, the data in a base layer 1302 is transmitted over a first carrier frequency f1 as a first bitstream 1310, while data in a first enhancement layer 1304 (i.e., second bitstream 1312) and a second enhancement layer 1306 (i.e., third bitstream 1314) is transmitted over a second carrier frequency f2. The data in the base layer 1302 may include I-frames (i.e., Intra-coded picture) and/or P-frames (also known as a predicted picture). The data in the first enhancement layer 1304 and/or second enhancement layer 1306 may include B-frames (also know as Bi-predictive picture). For example, the second enhancement layer 1306 may provide refinement data to enhance the content characteristic (e.g., quality, resolution, frame rate, bit depth, or multi-view characteristic) of the base layer 1302 from QVGA to VGA in the same bitstream. In this manner, spatial scalability and temporal scalability may be provided to support VGA-resolution content in a FLO network. Note that the base layer bitstream 1310 (i.e., or frames therein) may include header information that indicates which enhancement layer bitstream(s) (i.e., or frames therein) may be used and/or the corresponding carrier frequency for such enhancement layer bitstream(s).

Alternatively, data in the second enhancement layer 1306 (or third bitstream 1314) may provide refinement data corresponding to all the frames in both the base layer 1302 (or first bitstream 1310) and the first enhancement layer 1304 (or first bitstream 1312) in the same program content channel.

According to one feature, high definition content may be obtained by the second transmitter device 1002 from the content provider device 1002. The MCSB transcoders 1008 may code the second enhancement layer 1306 with spatial scalable enhancement information that is predicted using the base layer 1302 and first enhancement layer 1304 data. For example, the base layer 1302 (transmitted by the first transmitter 502 as the first bitstream 1310) may correspond to QVGA@15 fps, the first enhancement layer 1304 (transmitted by the second transmitter device 1002 as the second bitstream 1312) increases performance to full frame rate of 30 fps, and the second enhancement layer 1306 (also transmitted by the second transmitter device 1002 as third bitstream 1314) may increase spatial resolution to, for example, from QVGA to VGA at full frame rate. Data in the first enhancement layer 1304 and second enhancement layer 1306 may be transmitted using non-layered modes of the second carrier frequency f2 and the MCSB modulator 1012 (FIG. 12) may be configured to provide the desired coverage (e.g., co-extensive with the coverage for the base layer transmission) using parameters such as transmit power, outer coding method and rate, inner coding rate, etc.

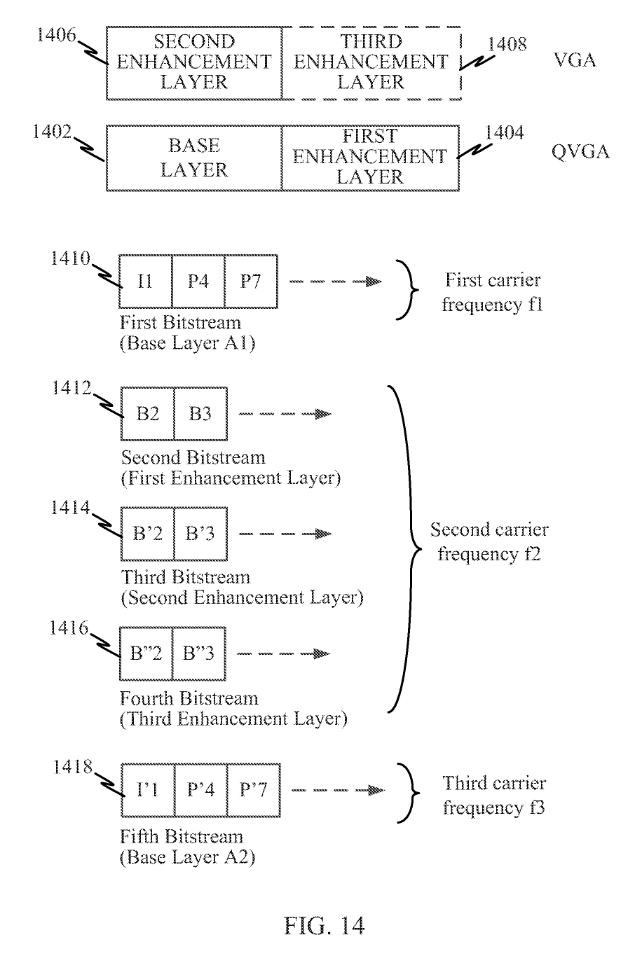

FIG. 14 illustrates a second configuration for transmitting multimedia content as a base layer and one or more enhancement layers over different carrier frequencies. In this configuration, the base layer 1402 is transmitted over a first carrier frequency f1 as a first bitstream 1410, while data in a first enhancement layer 1404 (or second bitstream 1412), data in a second enhancement layer 1406 (or third bitstream 1414), and a third enhancement layer 1408 (or fourth bitstream 1416) are transmitted over a second carrier frequency f2. For example, the second enhancement layer 1406 (or third bitstream 1414) may provide refinement data to enhance a content characteristic (e.g., a quality, resolution, frame rate, bit depth, or multi-view characteristic) of the base layer 1402 (e.g., data in the first bitstream 1410) and/or first enhancement layer 1404 (e.g., data in the second bitstream 1412) from QVGA to VGA in the same program content channel. Meanwhile, the third enhancement layer 1408 (e.g., fourth bitstream 1416) may be used to provide refinement data to enhance the content characteristic (e.g., quality, resolution, frame rate, bit depth, and/or multi-view characteristic) of another base layer (e.g., data in fifth bitstream 1418) and/or enhancement layer in a different or separate program content channel. In this manner, spatial scalability and temporal scalability may be provided to support VGA-resolution content in a FLO network.

In either case, the second enhancement layer and/or third enhancement layer data can be transmitted over an enhancement layer carrier (ELC) (e.g., second carrier frequency f2) to enable VGA mobile TV service for handhelds, portable devices and automobiles.

Referring again to FIG. 12, a third transmitter device 1202 may be configured similar to the first (MediaFLO) transmitter device 502. The third transmitter device 1202 may include a streaming server 1206 with a bank of program channel transcoders 1208, a multiplexer 1210, a modulator 1212, a FLO transmitter 1214, and an antenna 1216. The third transmitter device 1202 may transmit base layer data (non-layered) for additional program content channel(s) over a third carrier frequency f3. The second (MCSB) transmitter device 1002 may receive source and/or enhancement layer data (e.g., from the content provider device 1004) for these additional program content channel(s), generates the fourth bitstream 1416 for enhancement layer data for these additional program content channel(s), and transmits it over the second carrier frequency f2. Note that the one or more enhancement layer bitstreams 1412, 1414, and/or 1416 may be multiplexed or otherwise combined or modulated for transmission over the second carrier frequency channel f2. Also note that bitstreams 1412, 1414 and/or 1416 may contain coded frames corresponding to temporal, spatial, and/or other forms of scalability. Frames B, B′ and B″ are merely examples of coded frames.

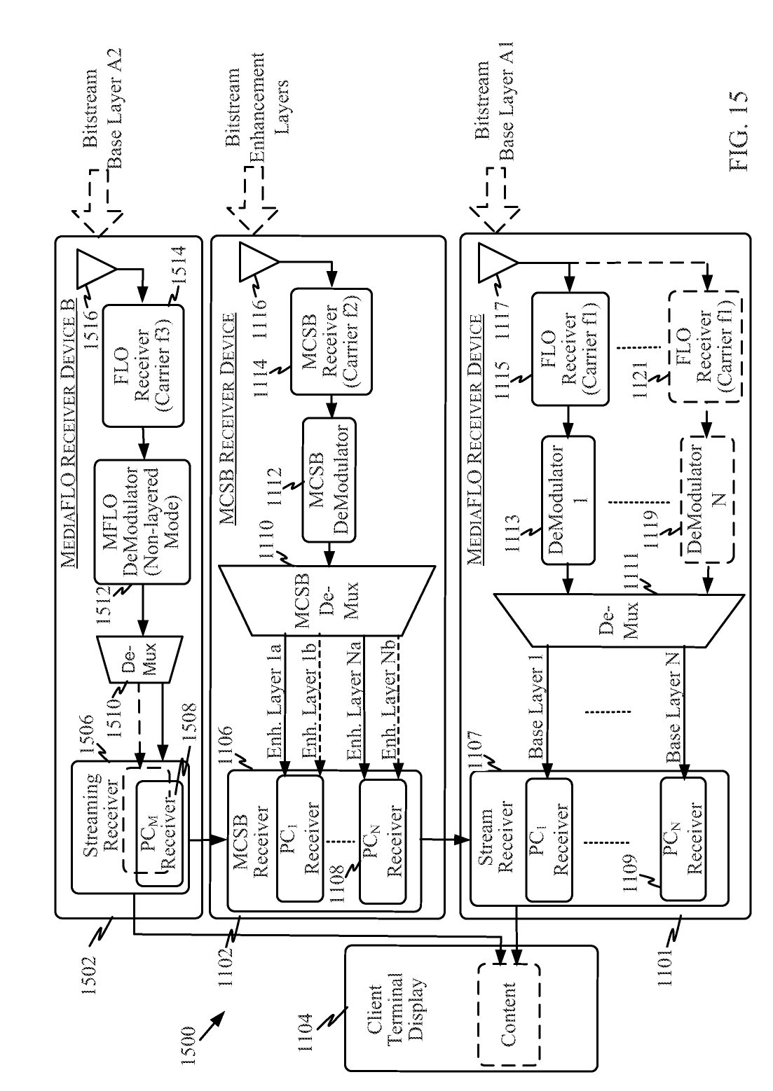

FIG. 15 illustrates a block diagram of a receiver device 1500 in which performance of the enhancement layer in an existing single-carrier network is improved by using an additional enhancement layer carrier. The receiver device 1500 may be similar to that illustrated in FIG. 11 but configured for reception of program content channels transmitted according to the transmission schemes of FIGS. 13 and 14. The receiver device 1500 may include the first (MediaFLO) receiver device 1101 and second receiver device 1102 along with a third transmitter device 1502. In this implementation, the first receiver device 1101 may be configured to receive a base layer bitstream (non-layered). The second receiver device 1102 may be configured to receive one or more enhancement layers corresponding to one or more base layer bitstreams. The third receiver device 1502, may include an antenna 1516 and FLO receiver 1514 to receive signal transmissions (e.g., carrier f3) including hierarchically modulated video content. The received signal transmission is demodulated by the demodulator 1512 and demultiplexed by a demultiplexer 1510. The demultiplexer 1510 decomposes the received signal transmission into a plurality of MediaFLO logical channels (MLCs), each of which may be a program content channel represented by a base layer and/or an enhancement layer(s). For each MLC, a program/content channel receiver 1508 captures the program content channel, reconstructs the data stream (e.g., base layer data and enhancement layer data) to its transmitted resolution (or original content characteristic) which can then be provided to the client terminal display 1104 for display. Note that while the third receiver device 1502 may receive a base layer(s) bitstreams for a second set of program content channels, the corresponding enhancement layer(s) may be received by the second receiver device 1102.

The features illustrated in FIGS. 10-15 enhance the performance of current MediaFLO networks using the existing network infrastructure by providing network scalability through multiple performance enhancement layers. As illustrated in FIGS. 13 and 14, these features decouple the enhancement layer MAC/PHY transmission path from base layer path, thus enabling an independent, flexible enhancement layer that can be optimized irrespective of the base layer. This approach minimizes “cross-talk” or interference between base layer and enhancement layer program content channels, thus enhancing coverage and SNR performance of both the base layer and enhancement layer. Because the enhancement layer is completely orthogonal to the base layer, this facilitates better quality-of-service (QoS) performance on each of these layers. This approach also allows adjusting enhancement layer parameters (e.g., bitrate, etc.) independent of the base layer parameters. Hence different types of scalability (SNR, temporal, etc.) can be supported as desired on a program content channel basis and scalability can be adaptable. This approach may also facilitate spatial scalability to much higher resolutions that the prior art approach cannot support. As illustrated in FIG. 14, the approach disclosed herein also permits sharing the enhancement layer carrier frequency among multiple base layer carrier frequencies promote a joint multi-carrier optimization across a multitude of services (e.g., some base layer program content channels may be enhanced while others are not). For instance, premium program content channels, 3D content video, and/or multi-view video can get better service (e.g., higher quality through bitrate, higher resolution/fps, etc.) and the scalability offered by a separate enhancement layer channel is much more scalable than the prior art architecture.

Another feature of implementing enhancement layer data transmissions separate from corresponding base layer transmissions is that the enhancement layer transmission is inherently more secure (than the base layer transmission) due to its dependency on base layer data. That is, because the enhancement layer transmission includes primarily refinement content (e.g., differential data), the video content for the program content channel cannot be ascertained merely by accessing the enhancement layer data. Hence, the enhancement layer data transmission may optionally be transmitted without encryption. Additionally, all the conditional access and digital rights management overhead data can be transmitted along with (or as part of) the base layer data transmission, eliminating the need for them to be retransmitted along with the enhancement layer data thus saving on bandwidth on the enhancement layer carrier (e.g., second carrier frequency f2).

By transmitting additional enhancement layers over a second carrier frequency f2, this may facilitate the establishment of new enhancement layer service without disruption to and leveraging existing subscription and authentications that have been established as part of a basic service (e.g., MediaFLO service).

### Targeted Enhancement Layer Transmissions Using Beam-Forming

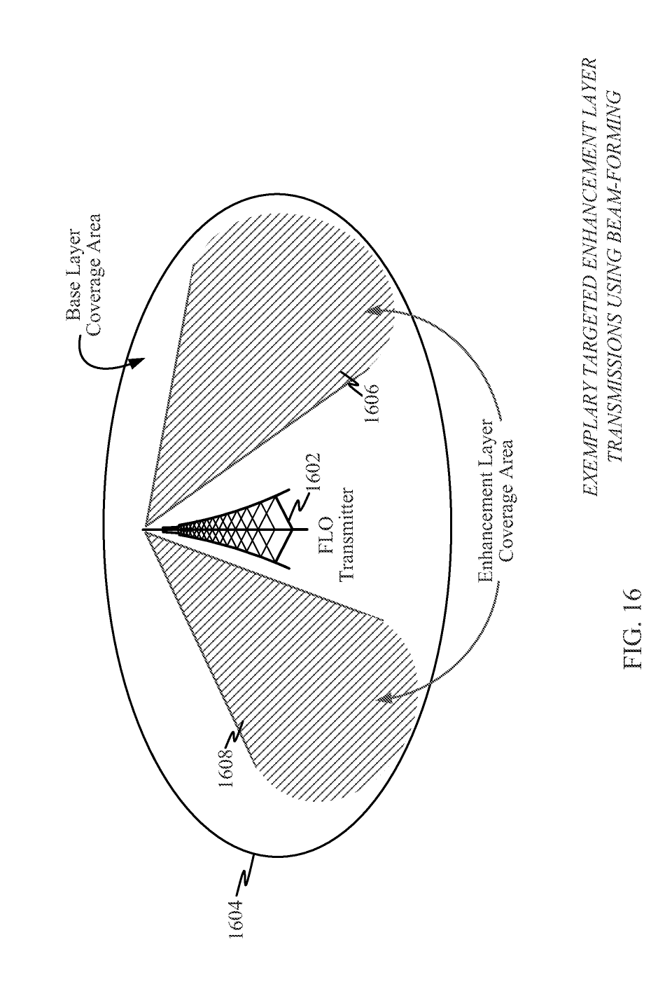

FIG. 16 illustrates an example of how one or more enhancement layer data transmissions may be localized using beam-forming. According to this approach, a forward link only (FLO) transmitter 1602 transmits base layer data using non-layered modes over a first carrier frequency f1 while transmitting enhancement layer data over a second carrier frequency f2. As illustrated here, the base layer data transmission may have a first coverage area 1604. The enhancement layer data is transmitted using directional beam forming techniques to target a smaller region or regions 1606 and/or 1608. These regions 1606/1608 could be localized by geographical region.

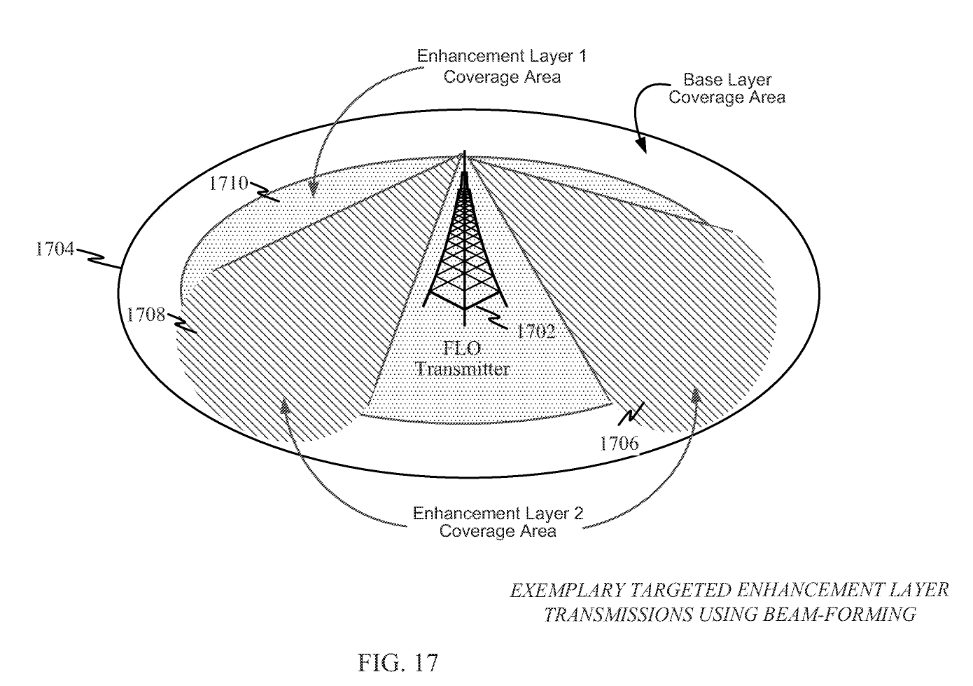

FIG. 17 illustrates another example of how one or more enhancement layer data transmissions may be localized using beam-forming. In this approach, the existing base layer plus enhancement layer scalability is maintained using layered transmission modes. According to this approach, a forward link only (FLO) transmitter 1702 transmits base layer data using a layered mode over a first carrier frequency f1 while transmitting a first enhancement layer data over the same first carrier frequency f1. As illustrated here, the base layer data transmission may have a first coverage area 1704 while the first enhancement layer data transmission may have a second coverage area 1710. Meanwhile, data for a second enhancement layer (e.g., corresponding to spatial scalable bitstreams for VGA or WVGA service) may be transmitted using beam forming. In this example, the second enhancement layer may have coverage areas 1706 and 1708.

### Exemplary Transmitter Device

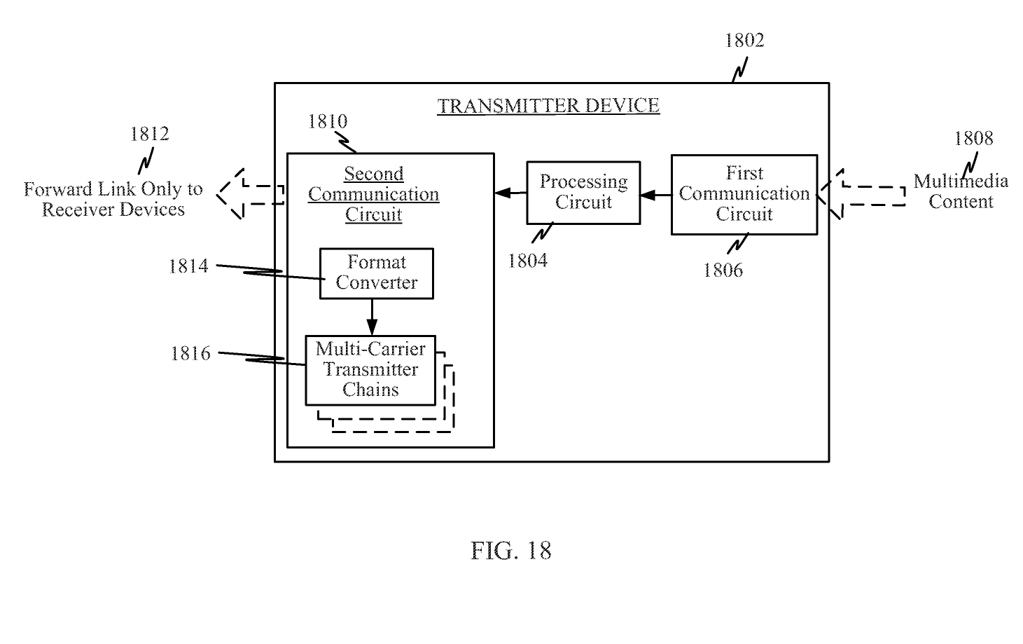

FIG. 18 is a block diagram of an example of a transmitter device configured to transmit scalable multimedia content over a plurality of carrier frequencies in a forward link only network. The client terminal 1802 may include a processing circuit 1804, a first communication circuit or interface 1806 for receiving/obtaining multimedia content 1808, and a second communication circuit or interface 1810 for sending/broadcasting one or more multimedia content channels over a forward link only network to receiver devices 1812. The second communication circuit 1810 may include a format converter 1814, and/or one or more multi-carrier transmitter chains 1816. In one example, the format converter 1814 may include one or more transcoders that convert a multimedia content from a first format to a second format. This may permit compressing the multimedia content from a higher resolution to lower resolution(s). A transmitter chain may include, for example, a multiplexer, modulator, radio frequency transmitter, and/or one or more antennas that allow processing, modulating, and/or transmitting one or more digital multimedia streams. The one or more multi-carrier transmitter chains 1816 may allow transmissions of multimedia content over different carrier frequencies.

In one example, the received multimedia content 1808 may include one or more multimedia content channels, where each multimedia content channel may include different content and/or programming. Each multimedia content channel may be converted to a forward link only logical channel for transmission, where each logical channel may be a compressed format or version of the originally received multimedia content channel. For example, multimedia content in a channel may be compressed into video frames such as I-frames (intra-coded picture frames), P-frames (predicted picture frames), and/or B-frames (bi-predictive picture frames). These frames may be transmitted, for example, as a base layer bitstream and one or more enhancement layer bitstreams. Therefore, a logical channel may be defined by a base layer bitstream and one or more enhancement layer bitstreams. The base layer bitstream may include sufficient portions of the multimedia content to reproduce a minimal quality/resolution of the multimedia content at a receiver device. For example, the base layer bitstream may include I-frames and/or P-frames for the multimedia content. Additionally, the one or more enhancement layer bitstreams may include refinement content (e.g., partial/differential multimedia content) for a corresponding base layer bitstream. For example, the base layer bitstream may include B-frames for the multimedia content. In one implementation, the base layer bitstream may be transmitted over a first carrier frequency f1 while the one or more enhancement layer bitstreams may be transmitted over a second carrier frequency f2. In one example, the first carrier frequency f1 may also serve to transmit a plurality of base layer bitstreams, each base layer bitstream corresponding to a different logical channel. Similarly, the second carrier frequency f2 may also serve to transmit a plurality of enhancement layer bitstreams, each enhancement layer bitstream corresponding to a different logical channel. The enhancement layer bitstream allows display of the multimedia content (at a receiver device) at a quality/resolution greater than the minimal quality/resolution of the multimedia content provided by the base layer bitstream. Because the base layer bitstream and the one or more enhancement layer bitstreams for a particular logical channel are transmitted over different carrier frequencies, they do not interfere with each other thereby allowing improved quality/resolution of multimedia content delivery to greater distances than in conventional hierarchical modulation systems.

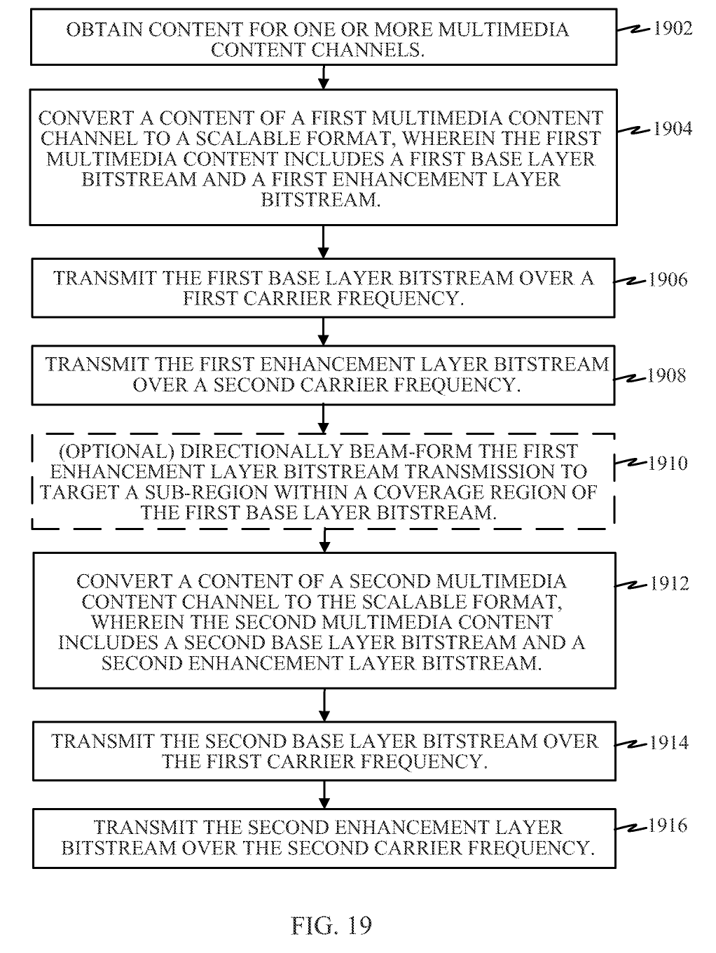

FIG. 19 is a diagram illustrating a method operational in a transmitter device to facilitate scalable multimedia content coding, modulation, and delivery over a multi-carrier transmission system. In one example, the transmitter device 1802 of FIG. 18 may implement this method. The transmitter device may obtain content for one or more multimedia content channels 1902. A content of a first multimedia content channel is then converted (e.g., by one or more transcoders) to a scalable format, wherein the first multimedia content includes a first base layer bitstream and a first enhancement layer bitstream 1904. The first enhancement layer bitstream may include refinement content associated with or for the first base layer bitstream. For instance, the first base layer bistream may include a plurality of intra-coded picture frames and predicted picture frames while the first enhancement layer bitstream may include a plurality of bi-predictive picture frames. The first base layer bitstream may provide the first multimedia content according to a first format, where a format refers to at least one of a quality, resolution, frame rate, bit depth, or multi-view characteristic. Meanwhile, the first base layer bitstream in combination with the first enhancement layer bitstream may provide the first multimedia content according to a second format, where the second format improves at least one characteristic of the first format.

The first base layer bitstream is then transmitted over a first carrier frequency 1906 and the first enhancement layer bitstream is transmitted over a second carrier frequency 1908. The first enhancement layer bitstream may be synchronously and/or concurrently transmitted with the first base layer bitstream. Additionally, the first enhancement layer bitstream may be orthogonally transmitted relative to the first base layer bitstream transmission. The first base layer bitstream transmission and the first enhancement layer bitstream transmission may have co-extensive coverage regions.

In one example, the first multimedia content further includes a second enhancement layer bitstream that enhances a display characteristic achievable by the first base layer bitstream in combination with the first enhancement layer bitstream. Such display characteristic may refer to, for example, at least one of a quality, resolution, frame rate, bit depth, or multi-view characteristic. The second enhancement layer bitstream is then transmitted over the second carrier frequency.

According to one feature, the first enhancement layer bitstream transmission may be directionally beam-formed to target a sub-region within a coverage region of the first base layer bitstream. In another example, the transmissions of the first base layer bitstream and first enhancement layer bitstream are omni-directionally broadcasted. The first base layer bitstream transmission and the first enhancement layer bitstream transmission may occur within a forward link only distribution network. The first base layer bitstream transmission may be non-hierarchically modulated.

According to one example, a content of a second multimedia content channel is converted to the scalable format, wherein the second multimedia content includes a second base layer bitstream and a second enhancement layer bitstream. Prior to transmission, the first and second base layer bitstreams may be multiplexed to create a first multiplexed bitstream prior to transmission. The first multiplexed bitstream is then transmitted over the first carrier frequency. Similarly, the first and second enhancement layer bitstreams may be multiplexed to create a second multiplexed bitstream prior to transmission. The second enhancement layer bitstream may then be transmitted over the second carrier frequency. The first and second base layer bitstreams may be multiplexed prior to transmission. The first and second enhancement layer bitstreams may be multiplexed prior to transmission.

According to yet another example, a content of a second multimedia content channel may be converted to the scalable format, wherein the second multimedia content includes a second base layer bitstream and a second enhancement layer bitstream. The second base layer bitstream may be transmitted over the third carrier frequency and the second enhancement layer bitstream may be transmitted over the second carrier frequency. Consequently, the second carrier frequency is shared by enhancement layer bitstreams of different multimedia content (e.g., content channels carried in the first base layer bitstream and second base layer bitstream).

Note that the base layer bitstreams and enhancement layer bitstreams may be transmitted or broadcasted over a mobile broadcast network, such as (for example) a Forward Link Only (FLO) network, a Digital Video Broadcasting-Handheld (DVB-H) network, an Integrated Services Digital Broadcasting-Terrestrial (ISDB-T)-compatible network, a Satellite Digital Multimedia Broadcasting (S-DMB)-compatible network, an Advanced Television Systems Committee-Mobile/Handheld (ATSC-M/H)-compatible network, among other types of networks.

### Exemplary Receiver Device

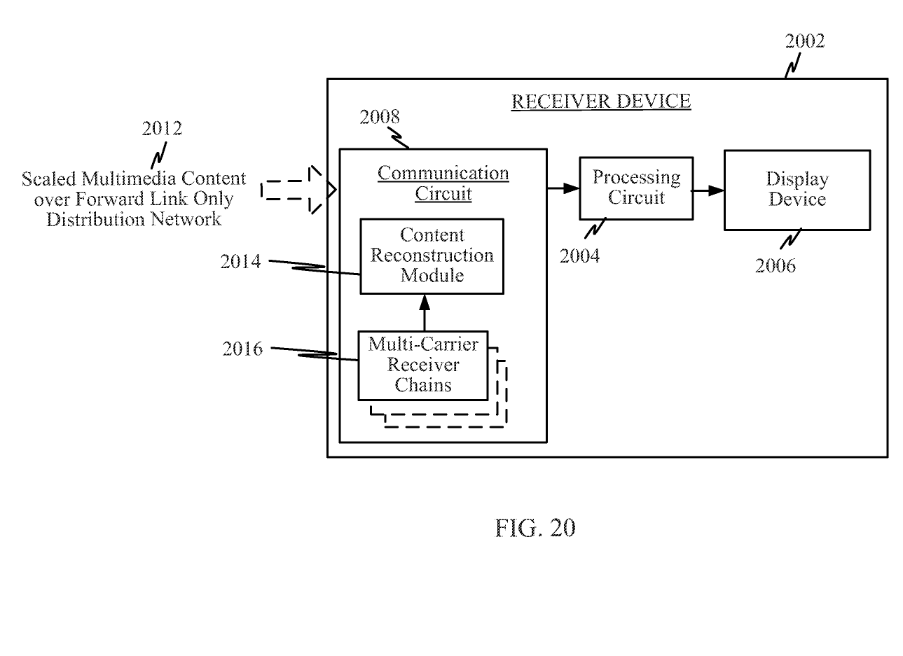

FIG. 20 is a block diagram of an example of a receiver device configured to receive scalable multimedia content over a plurality of carrier frequencies in a forward link only network. The receiver device 2002 may include a processing circuit 2004, a communication circuit 2008, and/or a display device 2006. The communication circuit 2008 may include one or more multi-carrier receiver chains 2016 and/or a content reconstruction module 2014. The one or more multi-carrier receiver chains 2016 may be configured to receive a base layer bitstream on a first carrier frequency f1 while receiving an associated or corresponding one or more enhancement layer bitstreams on a second carrier frequency f2. The content reconstruction module may then combine the received base layer bitstream and corresponding one or more enhancement layer bitstreams to obtain a scalable multimedia content for a logical/content channel.

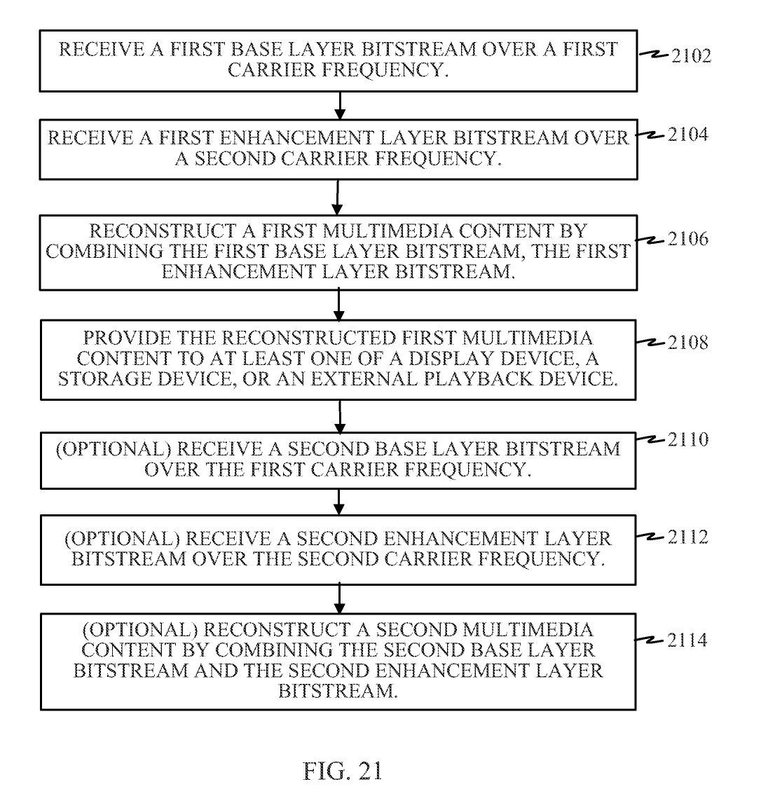

FIG. 21 is a diagram illustrating a method operational in a receiver device to facilitate scalable multimedia content reception and decoding scalable multimedia content transmitted over a multi-carrier transmission system. In one example, the receiver device 2002 of FIG. 20 may implement this method. The receiver device may receive a first base layer bitstream over a first carrier frequency 2102 and may receive a first enhancement layer bitstream over a second carrier frequency 2104. The first enhancement layer bitstream may include refinement content associated with the first base layer bitstream. Note that reception of the first base layer bitstream 2102 and reception of the first enhancement layer bistream 2104 may occur in any order (e.g., base layer bistream before first enhancement layer bitstream, or first enhancement layer bistream before first base layer bitstream). Additionally, the first base layer bitstream and first enhancement layer bitstream may be received at the same time or at different times.

The receiver device may then reconstruct a first multimedia content by combining the first base layer bitstream and the first enhancement layer bitstream 2106. Note that the first base layer bitstream and first enhancement layer bitstream may be linked or related, such that data from the first enhancement layer bitstream corresponds to data from the first base layer bitstream. The reconstructed first multimedia content may then be provided to at least one of a display device, storage device, or an external playback device 2108.

In one example, the first enhancement layer bitstream may be synchronously transmitted with the first base layer bitstream. Additionally, the first enhancement layer bitstream may be orthogonally transmitted relative to the first base layer bitstream transmission. This allows reduction of cross-interference between the first base layer bitstream and first enhancement layer bitstream.

In one implementation, the first base layer bistream may include a plurality of intra-coded picture frames and predicted picture frames. The first enhancement layer bitstream may include a plurality of bi-predictive picture frames.

In one example, the first base layer bitstream may provide the first multimedia content at a first resolution while the first base layer bitstream in combination with the first enhancement layer bitstream may provide the first multimedia content at a second resolution, where the second resolution is greater than the first resolution. The first base layer bitstream transmission and the first enhancement layer bitstream transmission may have co-extensive coverage regions. The first base layer bitstream and the first enhancement layer bitstream are received over a forward link only distribution network.

In one example, the first multimedia content may further include a second enhancement layer bitstream that enhances a display characteristic (e.g., at least one of a quality, resolution, frame rate, bit depth, or multi-view characteristic) achievable by the first base layer bitstream in combination with the first enhancement layer bitstream. The second enhancement layer bitstream may be received over the second carrier frequency.

In yet another implementation, the receiver device may also receive a second base layer bitstream over the first carrier frequency 2110 while also receiving a second enhancement layer bitstream over the second carrier frequency 2112. A second multimedia content (e.g., of a second multimedia content channel) may be reconstructed by combining the second base layer bitstream and the second enhancement layer bitstream 2114. The first and second base layer bitstreams may be demultiplexed from each other. Similarly, the first and second enhancement layer bitstreams may be demultiplexed from each other.

In another implementation, the receiver device may receive a second base layer bitstream over a third carrier frequency and may also receive a second enhancement layer bitstream over the second carrier frequency such that the second carrier frequency is shared by a plurality of enhancement layer bitstreams of different multimedia content (e.g., multimedia content having base layers transmitted over different carrier frequencies). A second multimedia content of a second multimedia content channel may be reconstructed by combining the second base layer bitstream and the second enhancement layer bitstream.

The methods described herein may be applied to scalable audio coding and/or scalable source coding in general. For instance, these methods can be applied to other terrestrial and satellite broadcast applications to extend performance of existing systems while maintaining backward compatibility.

One or more of the components, steps, features and/or functions illustrated in the figures may be rearranged and/or combined into a single component, step, feature or function or embodied in several components, steps, or functions. Additional elements, components, steps, and/or functions may also be added. The apparatus, devices, and/or components illustrated in the FIGS. may be configured to perform one or more of the methods, features, or steps described in the same or different FIGS. The novel algorithms described herein may also be efficiently implemented in software and/or embedded in hardware.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices and/or other machine-readable mediums, processor-readable mediums, and/or computer-readable mediums for storing information. The terms “machine-readable medium”, “computer-readable medium”, and/or “processor-readable medium” may include, but are not limited to non-transitory mediums such as portable or fixed storage devices, optical storage devices, and various other mediums capable of storing, containing or carrying instruction(s) and/or data. Thus, the various methods described herein may be fully or partially implemented by instructions and/or data that may be stored in a “machine-readable medium”, “computer-readable medium”, and/or “processor-readable medium” and executed by one or more processors, machines and/or devices.

Furthermore, embodiments may be implemented by hardware, software, firmware, middleware, microcode, or any combination thereof When implemented in software, firmware, middleware or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the invention. It should be noted that the foregoing embodiments are merely examples and are not to be construed as limiting the invention. The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A method operational in a transmitter device, comprising:
obtaining content for one or more multimedia content channels;
converting a content of a first multimedia content channel to a scalable format, wherein the first multimedia content includes a first base layer bitstream and a first enhancement layer bitstream;
transmitting the first base layer bitstream over a first carrier frequency; and
transmitting the first enhancement layer bitstream over a second carrier frequency.

2. The method of claim 1, wherein the first enhancement layer bitstream includes refinement content of the first base layer bitstream.

3. The method of claim 1, wherein the first enhancement layer bitstream is synchronously transmitted with the first base layer bitstream.

4. The method of claim 1, wherein the first enhancement layer bitstream is orthogonally transmitted relative to the first base layer bitstream transmission.

5. The method of claim 1, wherein the first base layer bistream includes a plurality of intra-coded picture frames and predicted picture frames.

6. The method of claim 1, wherein the first enhancement layer bitstream includes a plurality of bi-predictive picture frames.

7. The method of claim 1, wherein the first base layer bitstream provides the first multimedia content according to a first format, where a format refers to at least one of a quality, resolution, frame rate, bit depth, or multi-view characteristic.

8. The method of claim 7, wherein the first base layer bitstream in combination with the first enhancement layer bitstream provides the first multimedia content according to a second format, where the second format improves at least one characteristic of the first format.

9. The method of claim 1, wherein the first base layer bitstream transmission and the first enhancement layer bitstream transmission have co-extensive coverage regions.

10. The method of claim 1, wherein the first multimedia content further includes a second enhancement layer bitstream that enhances a display characteristic achievable by the first base layer bitstream in combination with the first enhancement layer bitstream where such display characteristic refers to at least one of a quality, resolution, frame rate, bit depth, or multi-view characteristic.

11. The method of claim 10, further comprising:
transmitting the second enhancement layer bitstream over the second carrier frequency.

12. The method of claim 1, further comprising:
directionally beam-forming the first enhancement layer bitstream transmission to target a sub-region within a coverage region of the first base layer bitstream.

13. The method of claim 1, wherein the transmissions of the first base layer bitstream and first enhancement layer bitstream are broadcasted with identical patterns.

14. The method of claim 1, wherein the transmissions of the first base layer bitstream and first enhancement layer bitstream are broadcasted with dissimilar patterns.

15. The method of claim 1, wherein the first base layer bitstream transmission and the first enhancement layer bitstream transmission are broadcasted within a mobile broadcast network.

16. The method of claim 1, wherein the first base layer bitstream transmission and the first enhancement layer bitstream transmission occur within a forward link only distribution network.

17. The method of claim 1, further comprising:
converting a content of a second multimedia content channel to the scalable format, wherein the second multimedia content includes a second base layer bitstream and a second enhancement layer bitstream;
multiplexing the first and second base layer bitstreams prior to transmission;
transmitting the second base layer bitstream over a first carrier frequency;
multiplexing the first and second enhancement layer bitstreams prior to transmission; and
transmitting the second enhancement layer bitstream over the second carrier frequency.

18. The method of claim 1, further comprising:
converting a content of a second multimedia content channel to the scalable format, wherein the second multimedia content includes a second base layer bitstream and a second enhancement layer bitstream;
multiplexing the first and second base layer bitstreams to create a first multiplexed bitstream prior to transmission;
transmitting the first multiplexed bitstream over a first carrier frequency;
multiplexing the first and second enhancement layer bitstreams to create a second multiplexed bitstream prior to transmission; and
transmitting the second multiplexed bitstream over the second carrier frequency.

19. The method of claim 1, further comprising:
converting a content of a second multimedia content channel to the scalable format, wherein the second multimedia content includes a second base layer bitstream and a second enhancement layer bitstream;
transmitting the second base layer bitstream over the third carrier frequency; and
transmitting the second enhancement layer bitstream over the second carrier frequency such that the second carrier frequency is shared by a plurality of enhancement layer bitstreams of different multimedia content.

20. A transmitter device, comprising:
a processing circuit adapted to:
obtain content for one or more multimedia content channels;
convert a content of a first multimedia content channel to a scalable format, wherein the first multimedia content includes a first base layer bitstream and a first enhancement layer bitstream;
a processing circuit coupled to the communication circuit, the communication circuit may be configured to:
transmit the first base layer bitstream over a first carrier frequency; and
transmit the first enhancement layer bitstream over a second carrier frequency.

21. The transmitter device of claim 20, wherein the first enhancement layer bitstream includes refinement content of the first base layer bitstream.

22. The transmitter device of claim 20, wherein the first enhancement layer bitstream is synchronously transmitted with the first base layer bitstream.

23. The transmitter device of claim 20, wherein the first base layer bitstream provides the first multimedia content according to a first format, where a format refers to at least one of a quality, resolution, frame rate, bit depth, or multi-view characteristic.

24. The transmitter device of claim 23, wherein the first base layer bitstream in combination with the first enhancement layer bitstream provides the first multimedia content at a second format, where the second format improves at least one characteristic of the first format.

25. The transmitter device of claim 20, wherein the first multimedia content further includes a second enhancement layer bitstream that enhances a display characteristic achievable by the combination of the first base layer bitstream in combination with the first enhancement layer bitstream, where such display characteristic refers to at least one of a quality, resolution, frame rate, bit depth, or multi-view characteristic.

26. The transmitter device of claim 25, wherein the communication circuit is further configured to:
transmit the second enhancement layer bitstream over the second carrier frequency.

27. The transmitter device of claim 20, wherein the communication circuit is further configured to:
directionally beam-form the first enhancement layer bitstream transmission to target a sub-region within a coverage region of the first base layer bitstream.

28. The transmitter device of claim 20, wherein the communication circuit is further configured to:
convert a content of a second multimedia content channel to the scalable format, wherein the second multimedia content includes a second base layer bitstream and a second enhancement layer bitstream;
transmit the second base layer bitstream over the third carrier frequency; and
transmit the second enhancement layer bitstream over the second carrier frequency such that the second carrier frequency is shared by a plurality of enhancement layer bitstreams of different multimedia content.

29. A transmitter device, comprising:
means for obtaining content for one or more multimedia content channels;
means for converting a content of a first multimedia content channel to a scalable format, wherein the first multimedia content includes a first base layer bitstream and a first enhancement layer bitstream;
means for transmitting the first base layer bitstream over a first carrier frequency; and
means for transmitting the first enhancement layer bitstream over a second carrier frequency.

30. The transmitter device of claim 29, further comprising:
means for converting a content of a second multimedia content channel to the scalable format, wherein the second multimedia content includes a second base layer bitstream and a second enhancement layer bitstream;
means for transmitting the second base layer bitstream over the third carrier frequency; and
means for transmitting the second enhancement layer bitstream over the second carrier frequency such that the second carrier frequency is shared by a plurality of enhancement layer bitstreams of different multimedia content.

31. A processor-readable medium having one or more instructions operational on a transmitter device for coding and transmitting scalable multimedia content, which when executed by a processor causes the processor to:
obtain content for one or more multimedia content channels;
convert a content of a first multimedia content channel to a scalable format, wherein the first multimedia content includes a first base layer bitstream and a first enhancement layer bitstream;
transmit the first base layer bitstream over a first carrier frequency; and
transmit the first enhancement layer bitstream over a second carrier frequency.

32. A method operational in a receiver device, comprising:
receiving a first base layer bitstream over a first carrier frequency; and
receiving a first enhancement layer bitstream over a second carrier frequency; and
reconstructing a first multimedia content by combining the first base layer bitstream and the first enhancement layer bitstream.

33. The method of claim 30, further comprising:
providing the reconstructed first multimedia content to at least one of a display device, a storage device, or an external playback device.

34. The method of claim 30, wherein the first enhancement layer bitstream includes refinement content of the first base layer bitstream.

35. The method of claim 30, wherein the first enhancement layer bitstream is synchronously received with the first base layer bitstream.

36. The method of claim 30, wherein the first enhancement layer bitstream is orthogonally received relative to the first base layer bitstream transmission.

37. The method of claim 30, wherein the first base layer bistream includes a plurality of intra-coded picture frames and predicted picture frames.

38. The method of claim 30, wherein the first enhancement layer bitstream includes a plurality of bi-predictive picture frames.

39. The method of claim 30, wherein the first base layer bitstream provides the first multimedia content according to a first format, where a format refers to at least one of a quality, resolution, frame rate, bit depth, or multi-view characteristic.

40. The method of claim 30, wherein the first base layer bitstream in combination with the first enhancement layer bitstream provides the first multimedia content according to a second format, where the second format improves at least one characteristic of the first format.

41. The method of claim 30, wherein the first base layer bitstream transmission and the first enhancement layer bitstream transmission have co-extensive coverage regions.

42. The method of claim 30, wherein the first multimedia content further includes a second enhancement layer bitstream that enhances a display characteristic achievable by the first base layer bitstream in combination with the first enhancement layer bitstream where such display characteristic refers to at least one of a quality, resolution, frame rate, bit depth, or multi-view characteristic.

43. The method of claim 42, further comprising:
receiving the second enhancement layer bitstream over the second carrier frequency.

44. The method of claim 30, wherein the first base layer bitstream and the first enhancement layer bitstream are received over a forward link only distribution network.

45. The method of claim 30, further comprising:
receiving a second base layer bitstream over a third carrier frequency;
receiving a second enhancement layer bitstream over the second carrier frequency such that the second carrier frequency is shared by enhancement layer bitstreams of different multimedia content; and
reconstructing a second multimedia content by combining the second base layer bitstream and the second enhancement layer bitstream.

46. A receiver device, comprising:
a communication circuit configured to:
receive a first base layer bitstream over a first carrier frequency; and
receive a first enhancement layer bitstream over a second carrier frequency; and
a processing circuit coupled to the communication circuit, the processing circuit adapted to:
reconstruct a first multimedia content by combining the first base layer bitstream and the first enhancement layer bitstream.

47. The receiver device of claim 46, wherein the processing circuit is further adapted to:
provide the reconstructed first multimedia content to at least one of a display device, a storage device, or an external playback device.

48. The receiver device of claim 46, wherein the first base layer bitstream provides the first multimedia content according to a first format, where a format refers to at least one of a quality, resolution, frame rate, bit depth, or multi-view characteristic.

49. The receiver device of claim 48, wherein the first base layer bitstream in combination with the first enhancement layer bitstream provides the first multimedia content according to a second format, where the second format improves at least one characteristic of the first format.

50. The receiver device of claim 46, wherein the first multimedia content further includes a second enhancement layer bitstream that enhances a display characteristic achievable by the first base layer bitstream in combination with the first enhancement layer bitstream where such display characteristic refers to at least one of a quality, resolution, frame rate, bit depth, or multi-view characteristic.

51. The receiver device of claim 46, wherein the communication circuit is further configured to:
receive a second base layer bitstream over a third carrier frequency;
receive a second enhancement layer bitstream over the second carrier frequency such that the second carrier frequency is shared by a plurality of enhancement layer bitstreams of different multimedia content; and
reconstruct a second multimedia content by combining the second base layer bitstream and the second enhancement layer bitstream.

52. A receiver device, comprising:
means for receiving a first base layer bitstream over a first carrier frequency; and
means for receiving a first enhancement layer bitstream over a second carrier frequency; and
means for reconstructing a first multimedia content by combining the first base layer bitstream and the first enhancement layer bitstream.

53. The receiver device of claim 52, wherein the communication circuit is further configured to:
means for receiving a second base layer bitstream over a third carrier frequency;
means for receiving a second enhancement layer bitstream over the second carrier frequency such that the second carrier frequency is shared by a plurality of enhancement layer bitstreams of different multimedia content; and
means for reconstructing a second multimedia content by combining the second base layer bitstream and the second enhancement layer bitstream.

54. A processor-readable medium having one or more instructions operational on a receiver device for receiving and decoding scalable multimedia content, which when executed by a processor causes the processor to:
receive a first base layer bitstream over a first carrier frequency; and
receive a first enhancement layer bitstream over a second carrier frequency; and
reconstruct a first multimedia content by combining the first base layer bitstream and the first enhancement layer bitstream.
